(19) United States
(12) Patent Application Publication
(10) Pub. No.: US 2012/0234108 A1
(43) Pub. Date: Sep. 20, 2012

(54) ISOLATED TORQUE SENSOR

(75) Inventors: Thomas F. Janecek, Flagstaff, AZ (US); Daniel S. Cole, Flagstaff, AZ (US)

(73) Assignee: MOTOR EXCELLENCE LLC, FLAGSTAFF, AZ (US)

(21) Appl. No.: 13/420,561

(22) Filed: Mar. 14, 2012

Related U.S. Application Data
(60) Provisional application No. 61/453,000, filed on Mar. 15, 2011.

(51) Int. Cl. G01L 3/10

(52) U.S. Cl. 73/862.338

(57) ABSTRACT

An isolated torque sensing device is described having a torque tube that may be configured in an axle of a bicycle or e-bike. A strain gauge is configured on either the inner or outer diameter of the torque tube. The torque sensor system may be configured in a 4-point bending configuration, wherein force from bearings within the axle, apply force to the torque tube.

### CROSS REFERENCE TO RELATED APPLICATIONS

The present invention claims the benefit of U.S. Provisional Patent Application No. 61/453,000, filed on Mar. 15, 2011, which is incorporated by reference herein, in its entirety.

### BACKGROUND

Various approaches for torque sensing, for example torque sensing associated with bicycles, are known in the art. However, many prior torque sensing systems are excessively large, complex, expensive, and/or require undesirable design tradeoffs in order to incorporate them into a vehicle, for example a bicycle. Accordingly, improved torque sensing systems, including torque sensing systems contained within and/or coupled to an electric motor, are desirable. It should be understood that torque sensing devices typically measure force exerted on an axle and not torque directly.

### SUMMARY

An isolated torque sensor system is provided having a torque tube that may be configured in an axle of a bicycle or e-bike. The torque tube experiences a strain response from a pedaling force, wherein at least a portion of the pedaling force is transferred to the torque tube via at least one support bearing. The torque tube is configured with a gap between the torque tube and the axle. A gap may be configured under the bearings in the axle and may have a reduced dimension or width in an elevated stop area as described herein. The strain gauge of the torque sensing system may be configured between two bearings in the axle. The torque sensing system may be configured in a 4-point bending system, or any other bending system including 3-point and the like. The torque tube may be configured with a variable diameter and may also comprise cutouts to increase the response to a forces applied to pedals.

The torque tube may be configured with a recess whereby electrical leads may be configured to run through or along said recess. The torque tube sensing system may be configured with the strain gauge substantially aligned with a portion of the drive chain in tension, as described herein. The torque tube may be configured around a bicycle axle wherein the strain gauge is disposed on the torque tube in a location within 15 angular degrees of the location on the torque tube closest to a bottom bracket.

The torque sensing system may comprise translatable torque plates with a pair of roller disposed therebetween as described herein. The torque sensing system may comprise a torque key as described herein. The torque tube may comprise flanges for retaining a support bearing. In addition, the torque tube may be configured to be stationary within the axle and not rotate or move substantially in any direction. It may be press fit, or be adhered or otherwise attached in place.

The torque sensing system may be configured to fit in the rear axle of a bicycle or e-bike having an electric motor. The strain gauge may be connected with the electric motor of an c-bike and provide a signal to the motor that changes the output from the motor. The motor may be a transverse or commutated flux motor.

The summary is provided to give a general introduction to several embodiments of the invention and is not meant to be limiting in any way. Other variations, combination, and embodiments are provided herein.

### BRIEF DESCRIPTION OF THE DRAWINGS

With reference to the following description and accompanying drawings:

FIG. 1 illustrates a block diagram of an exemplary torque sensing system in accordance with an exemplary embodiment;

FIGS. 2A-2C is an isometric view illustrating components of an exemplary torque sensing system in accordance with an exemplary embodiment;

FIG. 2D is an isometric view is an isometric view illustrates components of an exemplary torque sensing system coupled to a cassette body in accordance with an exemplary embodiment;

FIG. 2E is an isometric view illustrates components of an exemplary torque sensing system coupled to a cassette body and gear cassette in accordance with an exemplary embodiment;

FIG. 2F illustrates, in cut-away view, components of an exemplary torque sensing system in accordance with an exemplary embodiment;

FIG. 2G illustrates, in cut-away and zoomed view, components of an exemplary torque sensing system in accordance with an exemplary embodiment;

FIGS. 3A and 3B are isometric views illustrating components of an exemplary torque sensing system coupled to an electric motor in accordance with an exemplary embodiment;

FIG. 4A illustrates, in cut-away view, components of exemplary torque sensing system coupled to an electric motor in accordance with an exemplary embodiment;

FIG. 4B illustrates a closer cut-away view of the exemplary torque sensing system of FIG. 4A in accordance with an exemplary embodiment;

FIG. 5A is an isometric view illustrating a bicycle configured with a rear the axle in accordance with an exemplary embodiment;

FIG. 5B illustrates, in cut-away view, an exemplary electrical motor and exemplary torque sensing system utilized with the thru axle of FIG. 5A;

FIG. 5C illustrates, in cut-away view, a closer view of the exemplary torque sensing system of FIG. 5B in accordance with an exemplary embodiment;

FIG. 6 illustrates an exemplary torque sensing system coupled to a bicycle in accordance with an exemplary embodiment;

FIG. 7 illustrates, in cut-away view, an exemplary torque sensing system in accordance with an exemplary embodiment;

FIG. 8 illustrates, in cut-away view, an exemplary torque sensing system in accordance with an exemplary embodiment;

FIG. 9 illustrates, in cut-away view, an exemplary torque sensing system in accordance with an exemplary embodiment;

FIG. 10 illustrates, in cut-away view, an exemplary torque sensing system in accordance with an exemplary embodiment;

FIG. 11A illustrates a graph of rider input torque measured by an exemplary torque sensing system in accordance with an exemplary embodiment;

FIG. 11B illustrates a graph of rider input torque depicting an exemplary torque sensing system capturing torque readings from rider input on both pedals of a bicycle in accordance with an exemplary embodiment;

FIG. 11C illustrates a graph of rider input torque measured by an exemplary torque sensing system in accordance with an exemplary embodiment;

FIG. 11D illustrates a closer view of a portion of the graph of FIG. 11C in accordance with an exemplary embodiment; and

FIG. 12 illustrates a torque tube having a cutout in accordance with an exemplary embodiment.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the present disclosure.

For the sake of brevity, conventional techniques for torque, force, and/or displacement sensing, measurement, and/or control, as well as conventional techniques for bicycle configuration, utilization, and/or assembly, may not be described in detail herein. Furthermore, the connecting lines shown in various figures contained herein are intended to represent exemplary functional relationships and/or physical couplings between various elements. It should be noted that many alternative or additional functional relationships or physical connections may be present in a practical torque sensing system, for example as utilized in connection with an electric motor and/or electric generator.

Prior torque sensing systems, for example torque sensing systems for electric bicycles, suffer from various deficiencies. For example, many prior torque sensing systems for electric bicycles require a particular crankset or other customized components. Yet other prior torque sensing systems are excessively large and/or expensive. Still others introduce unwanted excessive slop or play into movement of the crankset, gear cassette, axle, or other components. Additionally, many prior torque sensing systems are capable of sensing only torque resulting from a force applied to one bicycle pedal, for example the pedal opposite the pedal to which a sprocket is affixed, and cannot sense torque resulting from a force applied to the other bicycle pedal. Yet further, many prior torque sensing systems are not “isolated”; stated another way, such prior torque sensing systems may be unable to differentiate between torque arising from a force applied by a rider to the pedals of a bicycle, torque arising from a force applied by an electric motor, torque arising from a vehicle traversing an uneven surface such as a pothole, and/or the like.

In contrast, various problems associated with prior torque sensing systems can be reduced and/or eliminated via use of a torque sensing system configured in accordance with principles of the present disclosure. For example, the need for customized cranksets can be eliminated. Excessive slop or play in the movement of the crankset, gear cassette, and/or axle can be reduced and/or eliminated. Moreover, torque resulting from a force applied to either bicycle pedal may be sensed. Additionally, “isolated” torque sensing can be achieved, for example sensing only of torque arising from a force applied by a rider to the pedals of a bicycle. Yet further, compact and inexpensive torque sensing systems can be implemented. By utilizing torque information, performance of bicycle motors and other bicycle components, and more generally, performance of electric vehicles, may be modified, refined, and/or otherwise improved, for example by regulating the output of an electric motor responsive to a force applied by a bicycle rider.

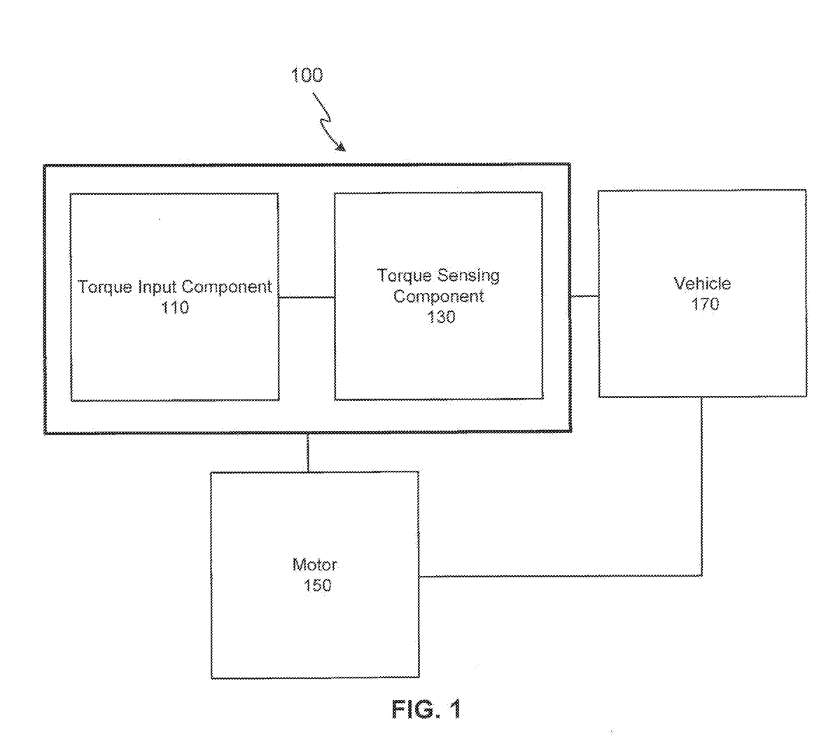

As used herein, a torque sensing system may be any system configured to measure a torque or other force, for example a torque resulting from the application of force to the pedals of a bicycle by a rider. Turning now to FIG. 1, in an exemplary embodiment a torque sensing system 100 configured in accordance with principles of the present disclosure generally comprises a torque input component 110 and a torque sensing component 130. Torque sensing system 100 may be coupled to a motor 150, for example an electric motor. Moreover, torque sensing system 100 may be integrated with and/or share one or more components with a motor 150. In various exemplary embodiments, torque sensing system 100 may be coupled to a vehicle 170. Motor 150 and vehicle 170 may also be coupled to one another and/or otherwise operatively linked.

In various exemplary embodiments, torque input component 110 can comprise one or more of a lever, an extrusion, a tube, a cassette body, a gear cassette, a bearing, and/or any other suitable component or combination of components configured to transfer a torque and/or other force to torque sensing component 130. In various exemplary embodiments, torque input component 110 comprises a bearing-supported cassette body of a rear gear cassette of a bicycle. Moreover, principles of the present disclosure may suitably be applied in connection with various electric motors and vehicles, and are not limited to bicycles.

Torque sensing component 130 is configured to respond to, measure, and/or otherwise react to an input force provided by torque input component 110. Torque sensing component 130 may comprise, for example, load cells, load bars, compression columns, piezoelectric materials, hydraulic pistons, springs, optical fibers, strain gauges, and/or any other suitable components, systems, and/or devices configured to react to and/or measure an applied force or result thereof.

Torque sensing system 100 may be coupled to and/or comprise a portion of vehicle 170. Vehicle 170 may comprise, for example, a manual bicycle, an electric bicycle where motor assistance is provided when the rider is pedaling (a “pedelec”), an electric bicycle where motor assistance is provided via a throttle (an “e-bike”), a motorcycle, a scooter, and/or any other suitable transportation device. In various exemplary embodiments, vehicle 170 is chain driven. In other exemplary embodiments, vehicle 170 may be driven via one or more of screws, belts, and/or the like.

Through use of a torque sensing system, for example torque sensing system 100 in FIG. 1, various shortcomings of prior torque sensing approaches and systems may be overcome. A desired torque may be measured (for example, a torque imparted by a bicycle rider via a pedaling force applied to the crankset) while reducing or eliminating excessive unwanted slop or play in the axle, gear cassette, and/or crankset (wobble, softness, and/or the like). Yet further, torque sensing may be provided on a bicycle without interfering with the ability to use standard cranksets and other components. Additionally, torque sensing systems configured in accordance with principles of the present disclosure can be “isolated”; stated another way, torque sensing systems configured in accordance with principles of the present disclosure can measure torque provided by a particular source (e.g., a bicycle rider) without simultaneously measuring torque or other forces provided by one or more other sources (e.g., an electric motor coupled to a bicycle, a bump in a road, the weight of a bicycle rider, and/or the like), allowing a more accurate assessment of rider torque input. More generally, application of principles of the present disclosure enables electric motors configured with integrated torque sensing capabilities, simplifying integration in various vehicles and other applications.

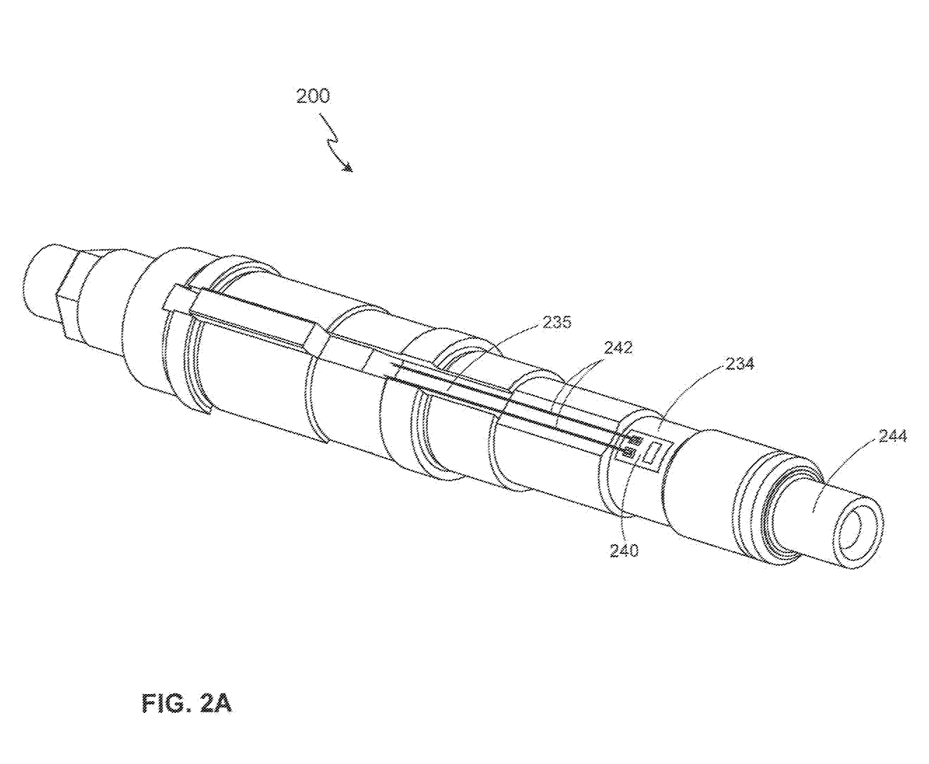

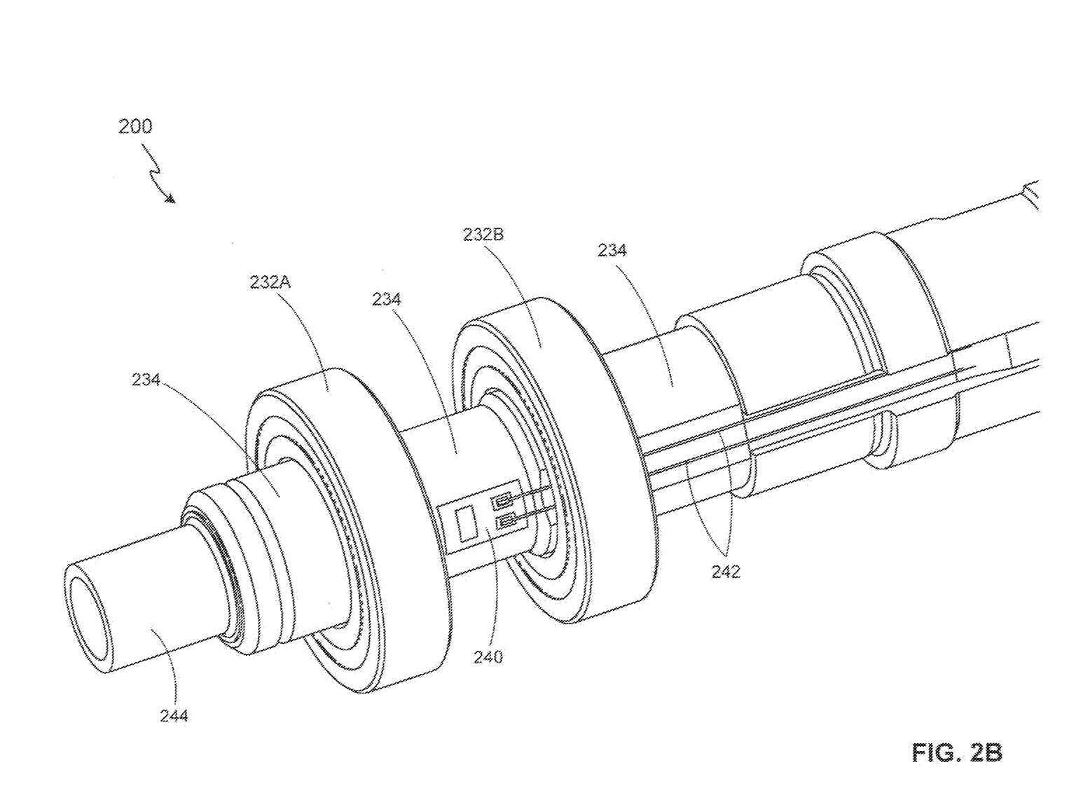

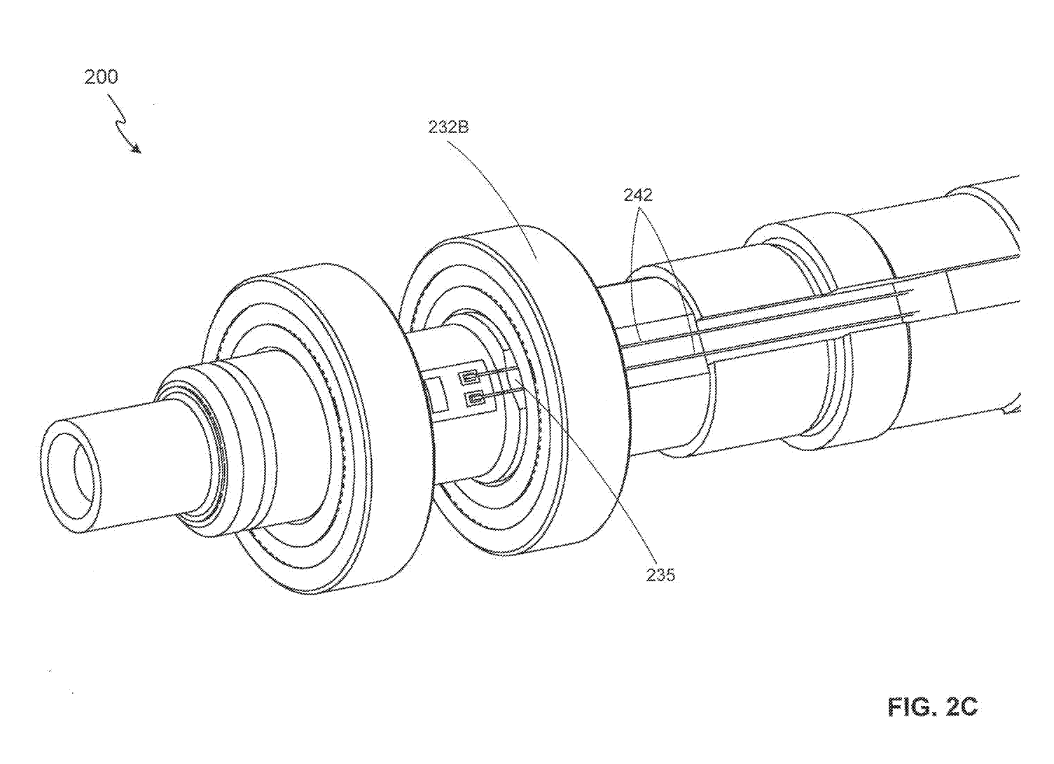

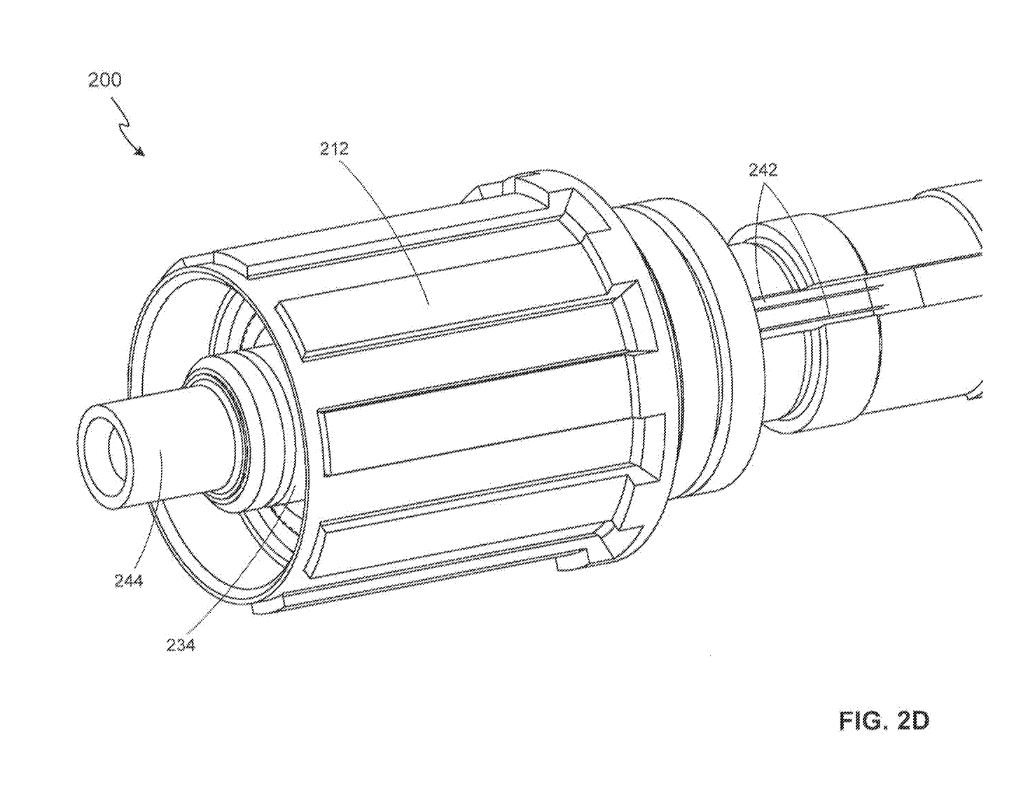

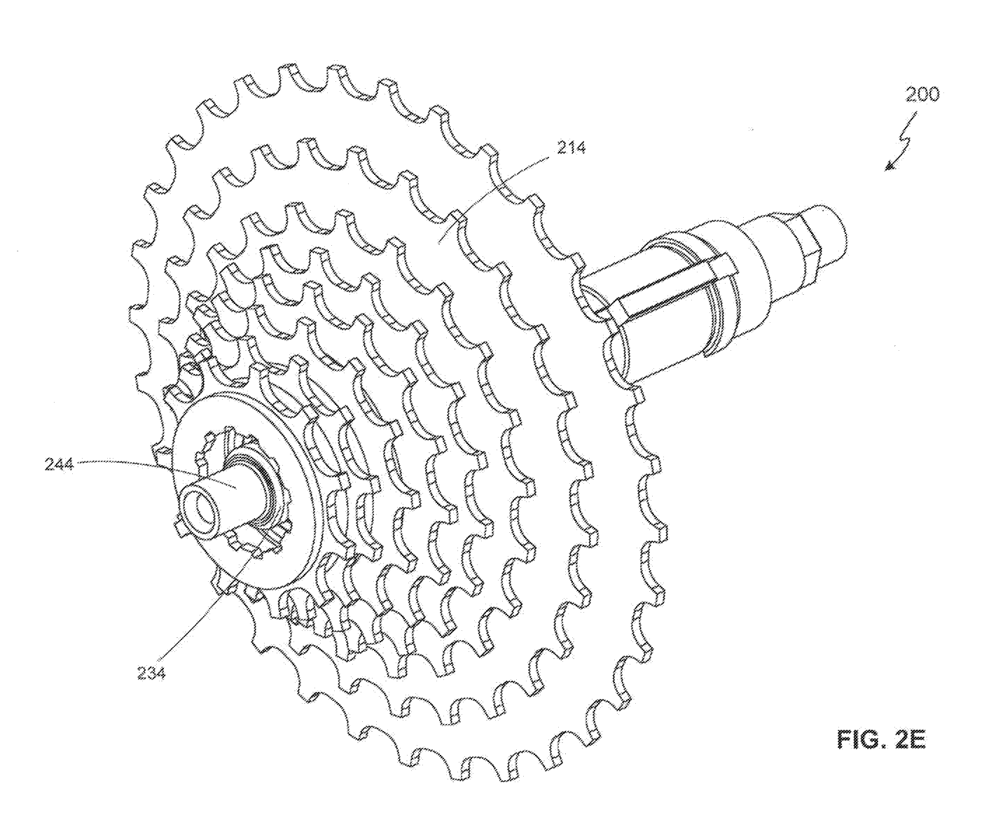

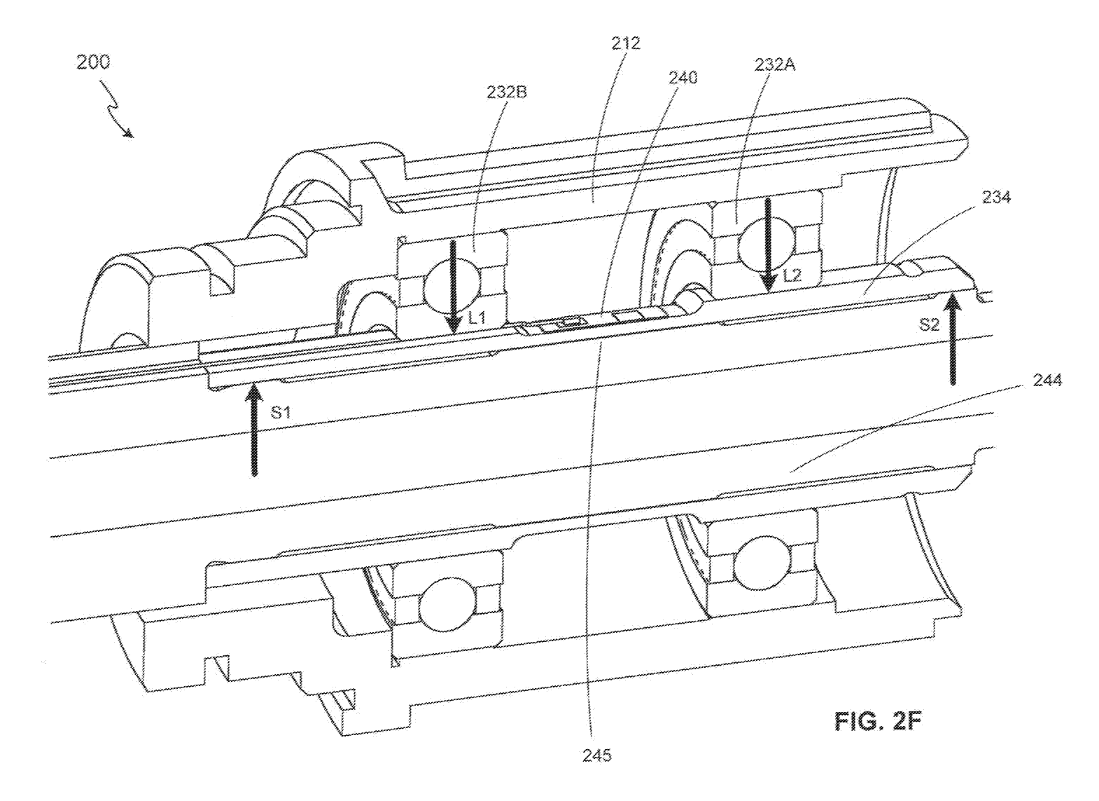

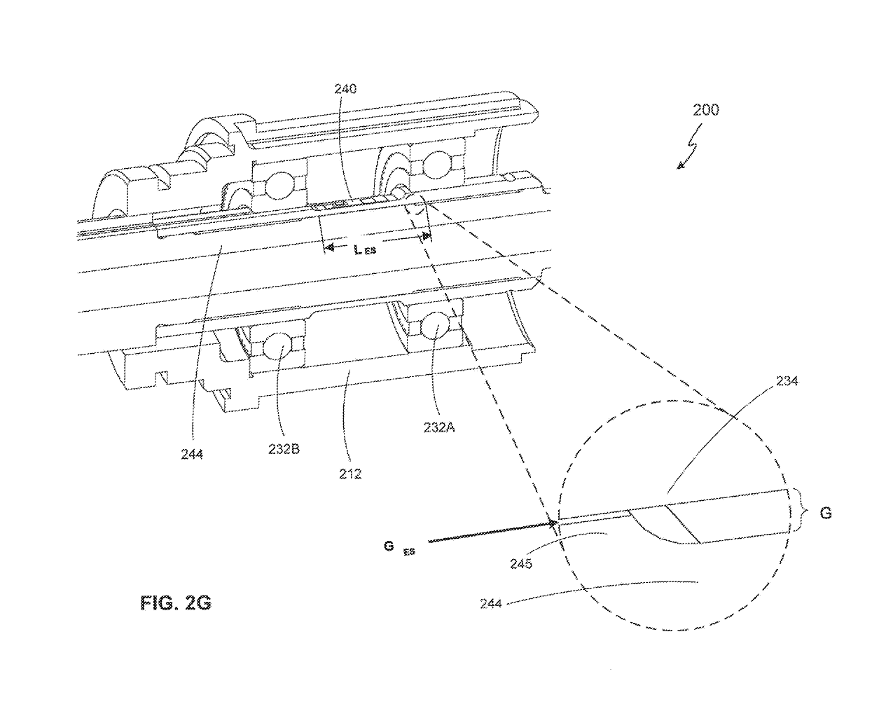

In an exemplary embodiment, and with reference now to FIGS. 2A-2G, a torque sensing system 100, for example torque sensing system 200, is configured for use in a vehicle, for example a pedelec or an e-bike. In this exemplary embodiment, torque sensing system 200 is configured to be disposed generally in the rear axle area of a bicycle. Torque sensing system 200 comprises a torque tube 234 having strain gauge 240 disposed thereon. Torque tube 234 is disposed about axle 244.

With momentary reference to FIGS. 2F and 2G, a gap G exists in at least a portion of the area between torque tube 234 and axle 244, allowing torque tube 234 to at least partially deform into gap G and experience a resulting strain measurable by strain gauge 240. In various exemplary embodiments, axle 244 is configured with an elevated stop 245 located at least beneath the area where strain gauge 240 is affixed to torque tube 234. Elevated stop 245 is configured to reduce the width of gap G_{ES} over at least a portion of gap G as shown in FIG. 26. The reduced gap G_{ES} may cause torque tube 234 to “bottom out” against elevated stop 245 prior to bottoming out against other portions of axle 244. In this manner, the displacement of torque tube 234 in the area of strain gauge 240 may be controlled and/or limited, consequently limiting the maximum amount of strain measured by strain gauge 240. In various exemplary embodiments, in the portion of gap G between torque tube 234 and elevated stop 245, gap G_{ES} may have any suitable width including but not limited to, greater than about 0.0254 mm (0.001 inches), greater than about 0.0508 mm (0.002 inches), greater than about 0.0762 mm (0.003 inches), greater than about 0.1016 mm (0.004 inches) and any range between and including the widths provided. Moreover, the width of gap G may be any suitable width configured to control, limit, and/or otherwise bound the amount of strain experienced by torque tube 234 in a particular area of torque tube 234 responsive to an applied force. The gap width may be greater to allow for wider machine tolerances over portions of the length of the gap, as shown in FIG. 2G. The gap G length may be any suitable length including, but not limited to, greater than about 5 mm, greater than about 10 mm, greater than about 15 mm, greater than about 20 mm, greater than about 40 mm, greater than about 60 mm, greater than about 100 mm, greater than about 150 mm, and any range between and including the lengths provided. The length of the reduced gap width or L_{ES}, as shown in FIG. 20, corresponding to the elevated stop, may be any suitable length including but not limited to, greater than about 5 mm, greater than about 10 mm, greater than about 15 mm, greater than about 20 mm, greater than about 40 mm, greater than about 60 mm, greater than about 100 mm, greater than about 150 mm, and any range between and including the lengths provided. The length of the torque tube may be any suitable length including, but not limited to, greater than about 5 mm, greater than about 10 mm, greater than about 15 mm, greater than about 20 mm, greater than about 40 mm, greater than about 60 mm, greater than about 100 mm, greater than about 1150 mm, and any range between and including the lengths provided.

In various exemplary embodiments, with specific reference to FIG. 2F, torque sensing system 200 is configured as a 4-point bending system. Torque tube 234 is supported by axle 244 at either end of torque tube 234, as shown by force arrows S1 and S2. Torque tube 234 is loaded by bearings 232A and 232B, as shown by force arrows L1 and L2. Torque sensor 240 is disposed on torque tube 234 between bearings 232A and 232B. In a 4-point bending system, this placement causes the strain experienced by torque tube 234 to be constant over the area covered by strain gauge 240, enabling improved accuracy and/or precision in the output of strain gauge 240. More generally, in a 4-point bending system the strain experienced in a bending beam is constant in the area between the loading points, and strains may desirably be measured in this area.

In various exemplary embodiments, the location on torque tube 234 covered by strain gauge 240 may be bent inward responsive to a force exerted by bearings 232A and 232B on the same side of torque tube 234, and the resulting strain may be measured by strain gauge 240. In other exemplary embodiments, the location on torque tube 234 covered by strain gauge 240 may be bent outward responsive to a force exerted by bearings 232A and 232B on the opposite side of torque tube 234, and the resulting strain may be measured by strain gauge 240.

Returning again to FIGS. 2A-2G, during operation of a vehicle, a force, for example a force generated by a bicycle rider pressing on a bicycle pedal, is transferred through gear cassette 214 to cassette body 212. A force is then transferred from cassette body 212 to torque tube 234 via bearings 232A and 232B disposed therebetween. Strain gauge 240 measures the resulting strain in torque tube 234. The output of strain gauge 240 may be accessed via any suitable method or components, for example via wires 242 passing through trench 246. Strain gauge 2401 may provide an analog output and/or a digital output, as desired. The output of strain gauge 240 may be processed via any suitable electronic components, for example one or more of amplifiers, filters, analog to digital converters, digital signal processors, microprocessors, and/or the like, in order to convert the output of strain gauge 240 into a measured and/or calculated torque value.

In an exemplary embodiment, one strain gauge 240 is coupled to torque tube 234. In other exemplary embodiments, two or more strain gauges 240 may be coupled to torque tube 234. For example, two or more strain gauges 240 may be coupled to torque tube 234 in order to increase the accuracy of a strain measurement, increase a signal to noise ratio, and/or the like. Multiple strain gauges 240 may be placed at any suitable location or locations on torque tube 234, and the output of multiple strain gauges 240 may be utilized to calculate an applied force and/or develop a profile of various applied forces over time.

Torque tube 234 may comprise any suitable components configured for operation of torque sensing system 200. In various exemplary embodiments, torque tube 234 comprises a generally cylindrical, continuous tube. In other exemplary embodiments, torque tube 234 may be configured with a generally ovoid, rectangular, hexagonal, and/or other suitable inner and/or outer profile. In various exemplary embodiments, torque tube 234 may be configured with various cutouts 288 such as apertures, holes, and/or the like. The cutouts may be configured to increase the amount of strain in the portion of torque tube 234 where strain gauge 240 is affixed. For example, torque tube 234 may be configured with two cutouts with generally symmetrical “beams” therebetween. The beams may be on opposing sides of torque tube 234. In this manner, torque tube 234 may be configured to be manufactured with reduced warping and/or other undesirable deformation of torque tube 234, while experiencing a suitable level of strain in one or more of the “beams” responsive to an applied force.

Additionally, torque tube 234 may be configured with various wall thicknesses, for example in order to be thinner at a location where strain is measured. In an exemplary embodiment, torque tube 234 is configured with a first wall thickness of between about 1 mm to about 1.5 mm in the areas generally adjacent bearings 232A and 232B. Torque tube 234 is also configured with a second wall thickness of between about 0.1 mm to about 0.75 mm in the area where strain gauge 240 is affixed. More generally, torque tube 234 may be configured with wall thicknesses of about 0.05 mm to about 2.5 mm. In this manner, torque tube 234 may be configured to receive a force from bearings 232 while registering sufficient strain where strain gauge 240 is affixed. For example, in various exemplary embodiments torque tube 234 is configured to register, responsive to a loading force transferred by bearings 232A and 232B, a strain of between about 1000 micro-strain units to about 1500 micro-strain units in the area where strain gauge 240 is affixed. Moreover, in other exemplary embodiments torque tube 234 is configured to register a strain of between about 500 micro-strain units to about 2000 micro-strain units. In general, torque tube 234 may be configured to register any suitable number of micro-strain units responsive to a loading force.

Torque tube 234 may be configured with any suitable measurements and/or dimensions, as desired. In an exemplary embodiment, torque tube 234 is configured with an inner diameter of just over 12 mm, for example, about 12.0508 mm (i.e. sized to admit an axle 244 having a diameter of 12 mm, plus a clearance of about 0.0254 mm (0.001 inches) all around. In another exemplary embodiment, torque tube 234 is configured with an inner diameter of just over 13 mm, for example, about 13.0508 mm (i.e. sized to admit an axle 244 having a diameter of 13 mm, plus a clearance of about 0.0254 mm (0.001 inches) all around). Moreover, torque tube 234 may be configured with an inner diameter providing a clearance of between about 0.0254 mm (0.001 inches) to about 0.127 mm (0.005 inches) for axle 244 disposed within torque tube 234. In various exemplary embodiments wherein torque sensing system 200 is utilized on a bicycle, torque tube 234 is configured with an inner diameter of between about 10 mm to about 18 mm. In other exemplary embodiments wherein torque sensing system 200 is utilized on a vehicle larger than a bicycle, for example a scooter, motorcycle, automobile, or truck, torque tube 234 is configured with an inner diameter of between about 20 mm to about 10 cm. Stated generally, torque tube 234 may be configured to receive and/or couple to axles 244 of various sizes, and the dimensions of torque tube 234 may be configured accordingly.

Moreover, in various exemplary embodiments, torque tube 234 is configured with a variable inner diameter. For example, torque tube 234 may be configured with an inner diameter requiring a press fit with axle 244 at a first end of torque tube 234 (for example, the end of torque tube 234 furthest from a gear cassette), and with an inner diameter sufficient for a slip fit with axle 244 at a second end of torque tube 234 (for example, the end of torque tube 234 closest to a gear cassette). For example, torque tube 234 may be configured to have a clearance of no more than 0.0254 mm (0.001 inches) at a first end, and a clearance exceeding 0.0254 mm (0.001 inches) at a second end. In this manner, torque tube 234 may be configured to slightly “wobble” and/or pivot with respect to axle 244. For example, allowing torque tube 234 to pivot and/or otherwise move in a limited range with respect to axle 244 allows torque tube 234 to more effectively isolate strain gauge 240 from undesirable forces, for example forces resulting from the weight of a rider, forces generated by an electric motor, forces resulting from a vehicle traversing bumps in a road, and/or the like. Moreover, when torque tube 234 is configured with a variable inner diameter, assembly of torque tube 234 and axle 244 is facilitated, as torque tube 234 can slip over at least a part of axle 244 before additional force is needed to push torque tube 234 into place.

In certain exemplary embodiments, torque tube 234 is coupled to axle 244 via a compressible material disposed therebetween, for example a series of O-rings disposed around axle 244 and located between axle 244 and torque tube 234. In these exemplary embodiments, torque tube 234 may be configured with a clearance with respect to axle 244 of between about 0.0254 mm (0.001 inches) to about 0.254 mm (0.010 inches). In these embodiments, the compressible material may compress responsive to a force exerted on torque tube 234 by bearings 232A and 232B, allowing torque tube 234 to “bottom out” against axle 244 at the ends of torque tube 234 and begin experiencing a strain measurable by strain gauge 240. The compressible material may be elastomeric and/or resilient, and may comprise one or more of plastic, polyurethane, silicone rubber, ethylene propylene diene monomer (EPDM) rubber, polychloroprene (neoprene), fluorocarbon-based synthetic rubbers (e.g., Viton® brand fluoroelastomers, and/or the like), styrene-butadiene (“Buna”) rubbers, thermoplastic vulcanizates (e.g., Santoprene™ brand elastomers and/or the like), and/or the like. The compressible material may also be configured to reduce vibration and/or noise within torque sensing system 100, and to reduce the feeling of “slop” or play between torque tube 234 and axle 244.

By utilizing a torque tube 234, torque sensing system 200 offers the ability to sense torque in the area of an axle without weakening the axle, for example as might be required if a portion of the axle was made thinner to facilitate measurement of a strain on the axle.

In an exemplary embodiment, strain gauge 240 is mounted on an outer surface of torque tube 234, for example in an area generally between bearings 232A and 232B. This placement can facilitate ease of installation, wire routing, and the like. However, when mounted on an outer surface, strain gauge 240 may be vulnerable to damage from cassette body 212. In other exemplary embodiments, strain gauge 240 is mounted on an inner surface of torque tube 234. When mounted on an inner surface, strain gauge 240 is more protected from damage from cassette body 212; however, strain gauge 240 may be more vulnerable to damage from axle 244 during installation of torque tube 234 on axle 244. Strain gauge 240 may be placed at any suitable location on torque tube 234 in order to measure a strain associated with torque tube 234.

Torque tube 234 may comprise any suitable materials having desired structural properties. In an exemplary embodiment, torque tube 234 comprises 2024-T4 aluminum. In another exemplary embodiment, torque tube 234 comprises 2024-351 aluminum. In certain exemplary embodiments, torque tube 234 may be hard anodized, shot peened, laser cut, water jet cut, or otherwise treated and/or modified. For example, torque tube 234 may be coated with a non-anodic coating (e.g., Alodine® brand coatings from Henkel Technologies and/or the like), processed via a sulfuric anodize (commonly referred to as a Type II anodize), hard anodized (commonly referred to as a Type III anodize), processed via an electroless nickel plating, and/or the like. In certain exemplary embodiments, torque tube 234 comprises one or more of 4130 steel, 4340 steel, 17-4 PH steel, 17-7 PH steel, or 15-5 steel. Moreover, torque tube 234 may comprise at least one of aluminum, steel, copper, brass, bronze, beryllium copper, ceramics, engineering plastics, and/or other suitable structural materials and/or combinations of the same. In general, torque tube 234 may be cast, pressed, sintered, die-cut, machined, stamped, bonded, laminated, polished, smoothed, bent, molded, plated, coated, extruded, tempered, and/or otherwise shaped and/or formed via any suitable method and/or apparatus.

In various exemplary embodiments, torque tube 234 is configured with a recessed and/or flat portion 235. Portion 235 is configured to allow wires 242 to pass under one or more bearings, for example bearing 232B. Portion 235 is also configured to provide room for one or more bearings to slide over torque tube 234, to facilitate alignment of torque tube 234 with respect to other components of a drivetrain (for example, in order to ensure strain gauge 240 is disposed on a portion of torque tube 234 generally facing the bottom bracket of a bicycle), and/or the like. In an exemplary embodiment, the strain gauge is aligned substantially with the portion of the chain, belt, pulley or other drive component that is under load, such as, for example, the top portion of a chain on a bicycle between the front chain ring and rear cassette.

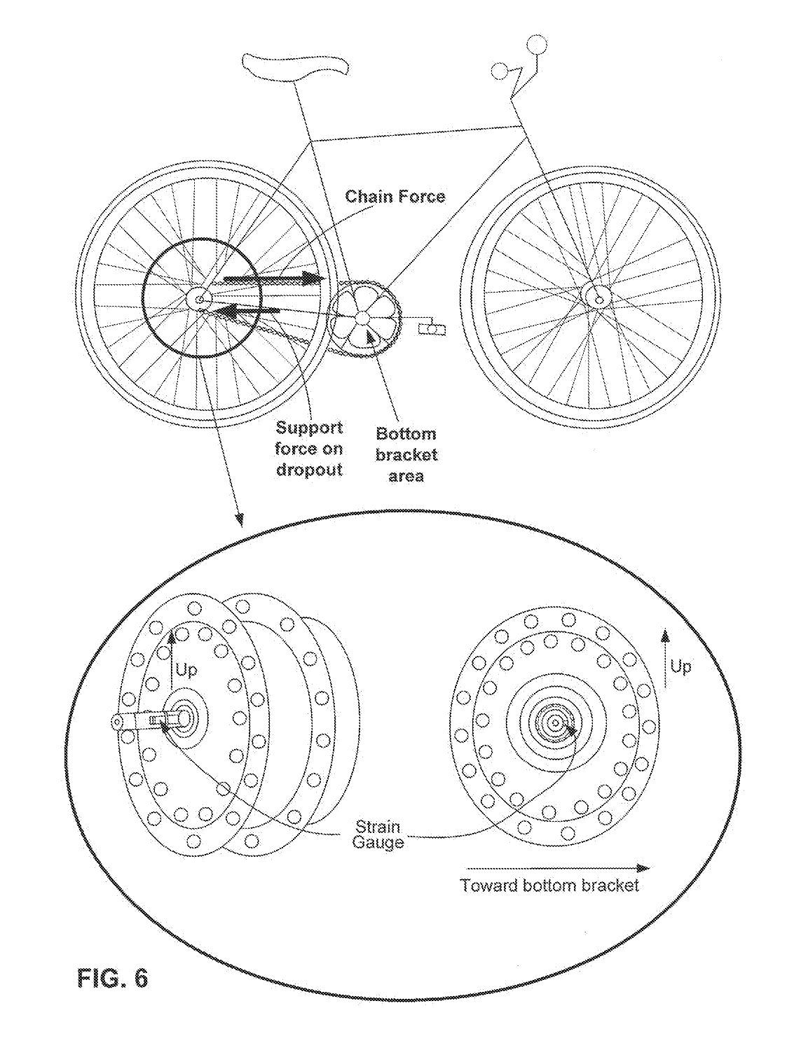

In various exemplary embodiments, torque tube 234 may be oriented with respect to the drivetrain of a vehicle. In general, torque tube 234 may desirably be oriented in a manner to generate a maximum amount of strain (or an amount of strain near the maximum value in the portion of torque tube 234 whereon strain gauge 240 is affixed. For example, with momentary reference to FIG. 6, in an exemplary embodiment wherein torque sensing system 200 is utilized in an electric bicycle, torque tube 234 is oriented such that strain gauge 240 is located at or near (for example, within about angular 15 degrees on either side) the location on torque tube 234 nearest the bottom bracket of the bicycle. In these orientations, torque tube 234 experiences a suitable level of strain measurable by strain gauge 240 due to the direction of the force exerted by the chain on gear cassette 214. Stated generally, in many alignments of torque tube 234, including alignments where strain gauge 240 is greater than 15 angular degrees away from the location nearest the bottom bracket of the bicycle, the output of strain gauge 240 may be suitably processed to assess peak torque changes and vary the output of motor 150 in response thereto. More specifically, however, aligning torque tube 234 to place strain gauge 240 at or near the area closest to the bottom bracket can enable more accurate calculation of the amount of input torque provided by a bicycle rider, enabling improved motor control, more detailed rider feedback re athletic performance, and/or the like.

In another exemplary embodiment wherein torque sensing system 200 is utilized in an electric bicycle, torque tube 234 is oriented such that strain gauge 240 is located at or near (for example, within about 15 angular degrees on either side) the location on torque tube 234 furthest away from the bottom bracket of the bicycle.

In various exemplary embodiments torque tube 234 is oriented such that torque tube 234 is loaded by bearings 232A and 23213 in non-cutout regions of torque tube 234. Stated another way, bearings 232A and 232B may be continuously engaged with torque tube 234 along the entire inner circumference of bearings 232A and 232B.

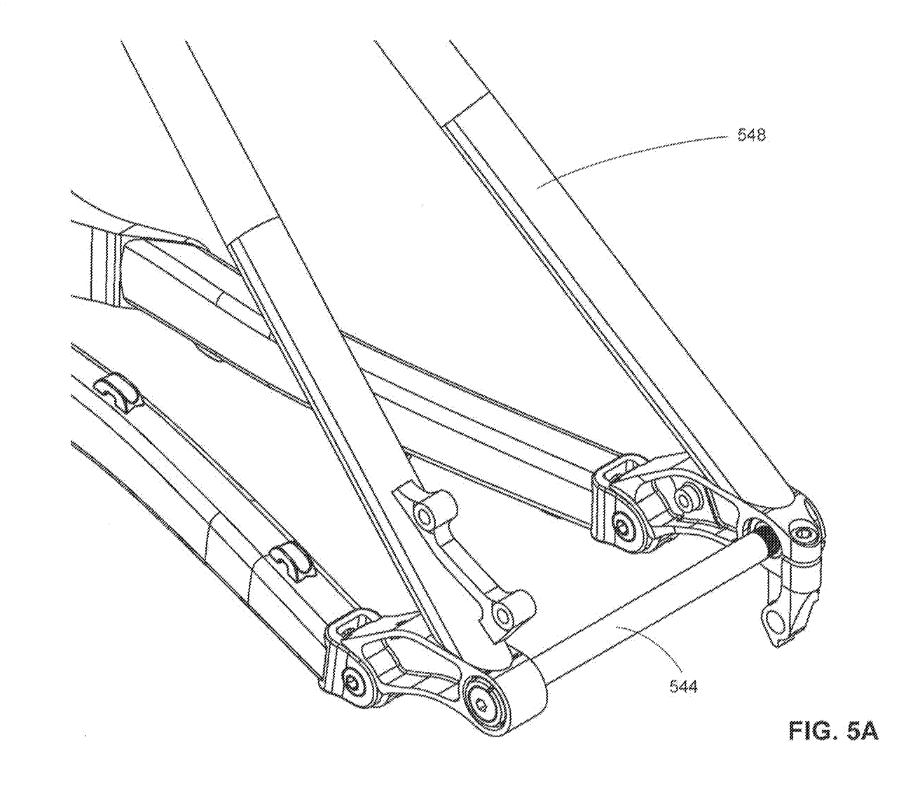

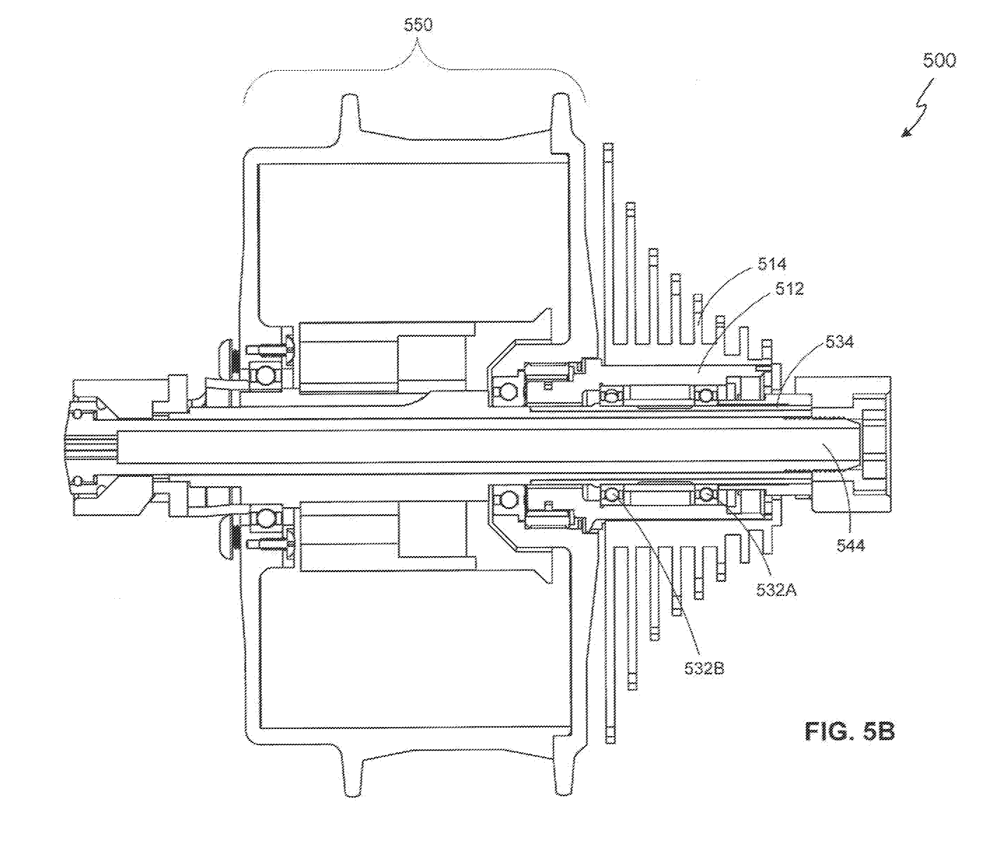

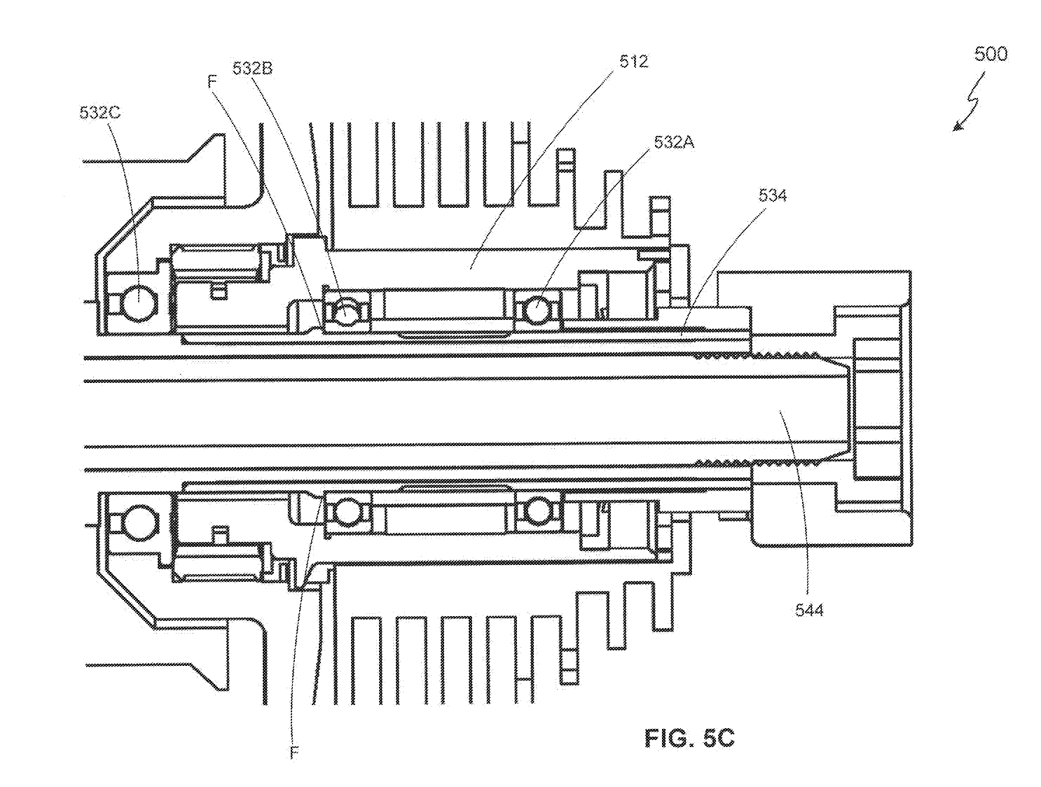

Returning to FIGS. 2A-2E, and with additional reference to FIG. 5C, in certain exemplary embodiments torque tube 534 is configured with one or more components configured to locate and or retain a bearing, for example one or more of bearings 532A, 532B, and/or 532C. In an exemplary embodiment, torque tube 534 is configured with a flange abutting bearing 532B on the side toward bearing 532C (e.g., at location F in FIG. 5C). In this manner, bearing 532B may be located with respect to torque tube 534. Additionally, an end cap, spacer, and/or other suitable components may be coupled to and/or interface with torque tube 534 in order to retain bearings 532A, 532B, and/or 532C in a suitable location. Moreover, various flanges, end caps, spacers, washers, and/or the like may be utilized in order to reduce and/or eliminate preload on bearings 532A, 532B, and/or 532C, and/or to reduce and/or eliminate axial load on torque tube 534. In this manner, strain arising from a force applied by a bicycle rider may be more accurately measured by torque sensing system 200, as strain arising from preload can be reduced.

In an exemplary embodiment, with reference again to FIGS. 2A-2E, strain gauge 240 comprises a Vishay Micro-Measurements brand J2A-13-S110K-10C strain gauge. In other exemplary embodiments, strain gauge 240 comprises a N2A-13-S1612-35B strain gauge, a J2A-13-S1425-35B strain gauge, a full-bridge strain gauge, and/or the like. Moreover, in various exemplary embodiments, strain gauge 240 is configured to measure strains resulting from a suitable range of applied forces, for example a range of forces capable of being generated by a bicycle rider (including ranges of such forces as mechanically magnified between a bicycle pedal and strain gauge 240). In an exemplary embodiment, strain gauge 240 is configured to measure strains resulting from a range of applied forces, for example from about 10 Newtons of force to about 5000 Newtons of force.

In various exemplary embodiments, strain gauge 240 may be releasably coupled to torque tube 234, for example via a removable fastener. In this manner, strain gauge 240 may be easily accessed, removed, replaced, reinstalled, upgraded, and/or the like, as desired. In other exemplary embodiments, strain gauge 240 may be fixably located in place, for example by welding, gluing, and/or the like. In these exemplary embodiments, torque tube 234 and strain gauge 240 may be installed and/or removed together. The output of strain gauge 240 may be utilized to calculate, estimate, and/or assess an amount of force, for example the amount of force applied by a rider to a pedal of a bicycle.

Strain gauge 240 may be coupled to a bicycle motor controller, a bike computer, or other electronic components, as desired. Strain gauge 240 may be coupled by wires; alternatively, wireless communication may be utilized. The output of one or more strain gauges 240 may be utilized (for example, via hardware and/or software processing) to calculate, assess, estimate, track, and/or monitor a force applied by a rider to a bicycle pedal, a force profile applied by a rider to a bicycle pedal over time, and/or the like. Moreover, the output of one or more strain gauges 240 may be utilized to control, modify, start, stop, and/or otherwise govern operation of a bicycle motor, for example responsive to a bicycle user applying a force to a bicycle pedal.

Additional sensors may be utilized as part of torque sensing system 200, as suitable. For example, temperature sensors may be utilized in order to account for changes in various material properties and/or positions (e.g., thermal changes in strain characteristics of a material comprising torque tube 234, changes in the output of strain gauge 240 responsive to variations in temperature, and/or the like).

Turning now to FIG. 2D, in various exemplary embodiments cassette body 212 is rotatably supported by bearings 232A and 232B not shown. In this manner, cassette body 212 can rotate about axle 244 and/or torque tube 234, which may remain fixed and non-rotating. Moreover, cassette body 212 can also transfer force to torque tube 234 disposed about axle 244. Cassette body 212 may comprise any suitable shape, configuration, and/or the like, as desired. In an exemplary embodiment, cassette body 212 comprises a Novatec/Joytech steel freehub for a 9 or 10 tooth gear cassette. In other exemplary embodiments, cassette body 212 comprises a Shimano brand freehub, an American Classic brand freehub, a Bontrager brand freehub, a Campagnolo brand freehub, DT Swiss brand freehub, and/or the like. Stated generally, cassette body 212 may comprise any cassette body compatible with integrated cartridge bearings, floating from the hub, and configured with a ratchet system or other suitable system to transfer torque.

Turning now to FIGS. 2E and 2D, in an exemplary embodiment gear cassette 214 is coupled to cassette body 212. Gear cassette 214 may comprise any suitable number of gears, for example 5 gears, 6 gears, 7 gears, 8 gears, 9 gears, 10 gears, and/or the like. Gear cassette 214 may be configured with any suitable gear tooth spacing and/or gear ratios, as desired. For example, gear cassette 214 may be configured with a gear having as few as 11 teeth (e.g., a gear diameter of about 46 mm). Moreover, gear cassette 214 may be configured with a gear having as many as 34 teeth (e.g., a gear diameter of about 134 mm). Gear cassette 214 may also be configured with any suitable dimensions, for example an axial length of between about 30 mm to about 40 mm. In various exemplary embodiments, gear cassette 214 is configured with the Shimano standard gear pattern as well known in the industry. In other exemplary embodiments, gear cassette 214 is configured with the Campagnolo gear pattern as well known in the industry. Moreover, any suitable gear pattern enabling transfer of force from a rider or other power source may suitably be utilized.

With reference again to FIG. 2B, in various exemplary embodiments bearings 232A and 232B are configured to rotatably support cassette body 212 while transferring force in a radial direction to torque tube 234. Bearings 232A and 232B may be sealed, have tolerances meeting or exceeding the ABEC 1 specification, and/or be sized as desired. For example, bearings 232A and 232B may be configured with suitable inner diameters in order to accommodate various thicknesses of torque tube 234 and/or axle 244.

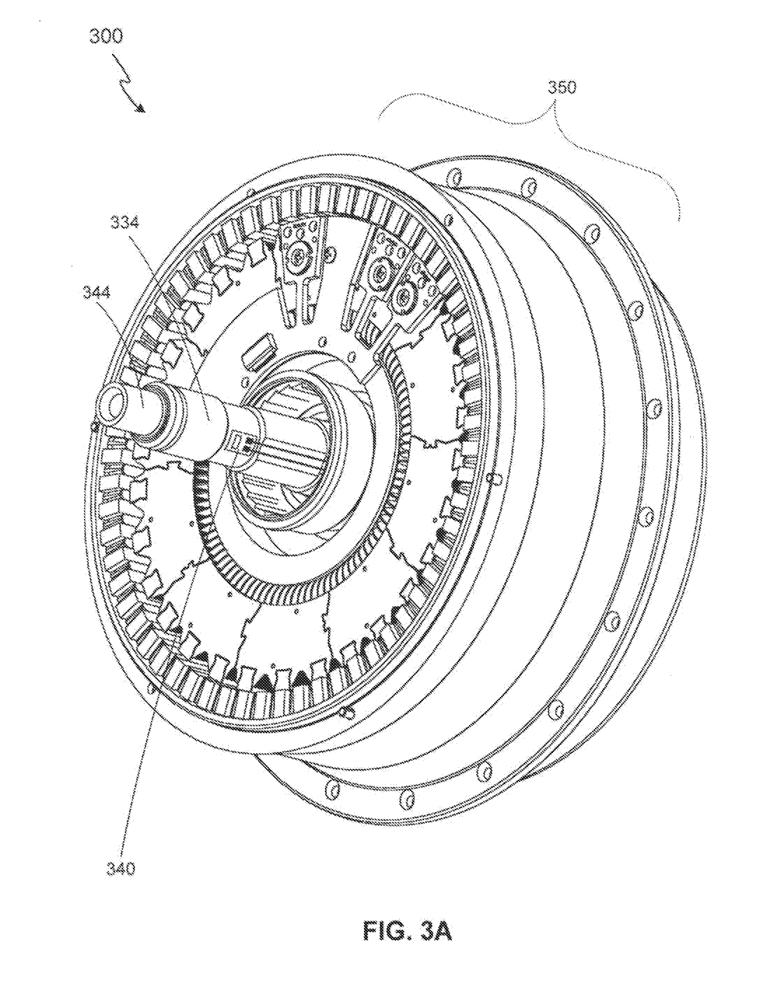

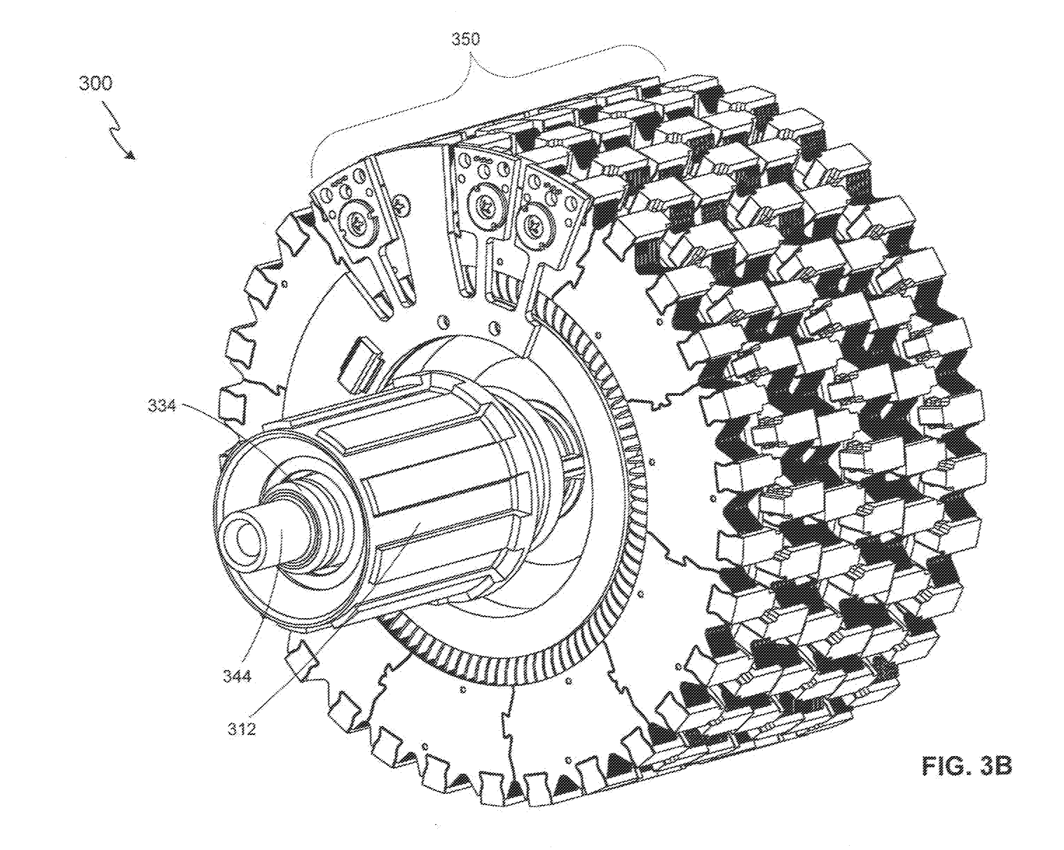

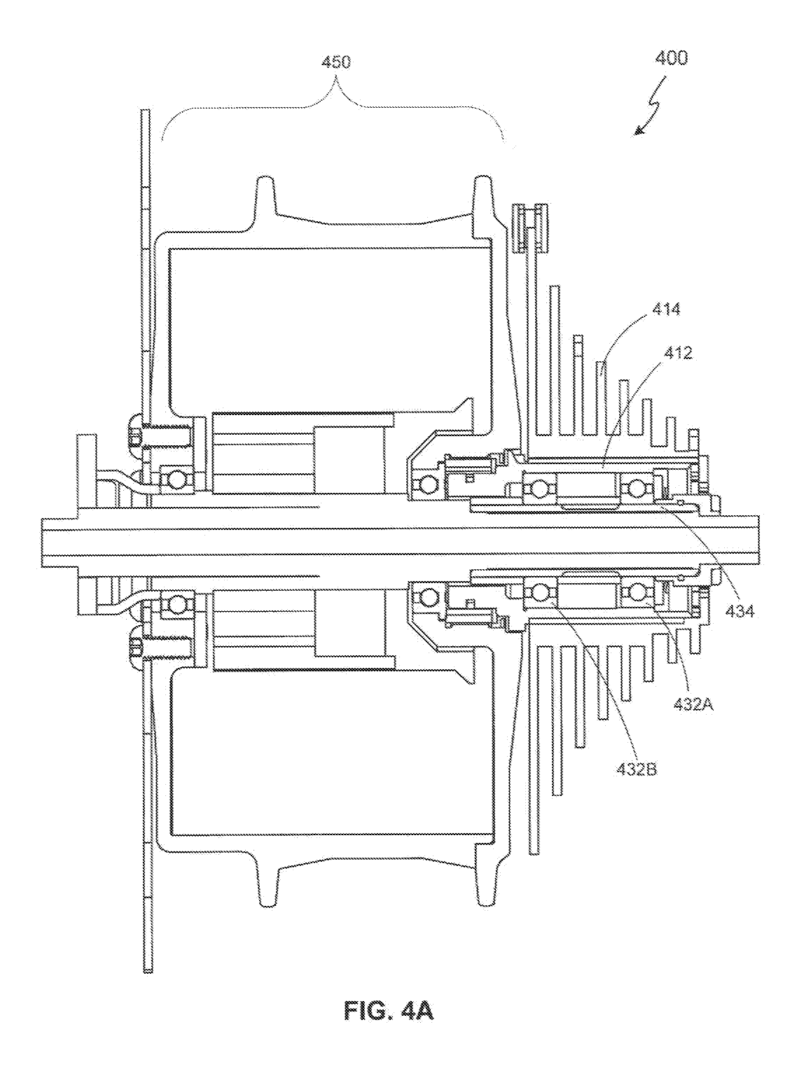

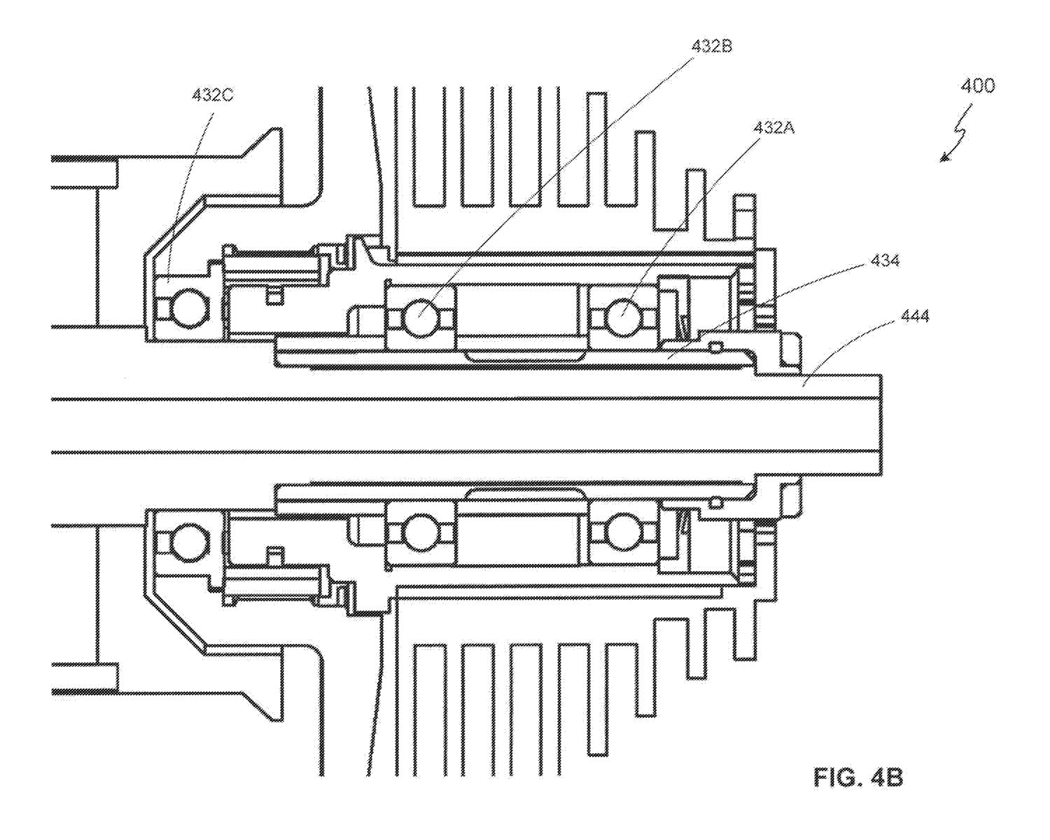

Turning now to FIGS. 3A through 4B, in various exemplary embodiments torque sensing system 100, for example torque sensing system 300 and/or 400, may be coupled to an electric motor and/or generator, for example transverse flux machine 350 and/or 450. Additional details regarding exemplary transverse flux machines and/or commutated flux machines suitable for use with exemplary torque sensing systems configured in accordance with principles of the present disclosure may be found in U.S. Provisional Patent Application Ser. No. 61/414,769 filed Nov. 17, 2010 and entitled “TRANSVERSE AND/OR COMMUTATED FLUX SYSTEMS HAVING SEGMENTED STATOR LAMINATIONS”, U.S. Provisional Patent Application Ser. No. 61/414,774 filed Nov. 17, 2010 and entitled “TRANSVERSE AND/OR COMMUTATED FLUX SYSTEM COIL CONCEPTS”, and U.S. Provisional Patent Application Ser. No. 61/414,781 filed Nov. 17, 2010 and entitled “TRANSVERSE AND/OR COMMUTATED FLUX SYSTEMS HAVING LAMINATED AND POWDERED METAL PORTIONS”. The contents of the all the foregoing applications are hereby incorporated by reference in their entirety.

Continuing to reference FIGS. 3A through 4B, in certain exemplary embodiments, transverse flux machine 350 and 450 rotate about axle 344 and 444, respectively. Torque tubes 334 and 434 are disposed around axles 344 and 444, respectively, and strain gauges 340 and 440 are affixed to torque tubes 334 and 434, respectively. In these embodiments, torque sensing system 300 and torque sensing system 400 are generally “isolated”, with torque generated by transverse flux machine 350 and transverse flux machine 450, rider weight, and forces due to uneven surfaces resulting in only a small amount of strain detectable by strain gauges 340 and 440, respectively. Stated another way, torque sensing systems 300 and 400 primarily detect strain responsive to pedaling forces transmitted through cassette body 312 and 412. Moreover, operation of torque sensing systems 300 and 400 may be similar to operation of torque sensing system 200 described above.

Turning now to FIGS. 5A through 5C, in accordance with various exemplary embodiments torque sensing system 100, for example torque sensing system 500, is configured to be compatible with bicycles configured with a motorcycle-style “thru axle”. In a thru axle system, the axle is clamped at each fork leg to improve lateral rigidity, as opposed to a conventional quick release dropout system. In an exemplary embodiment, torque sensing system 500 is configured to be compatible with the X-12 thru axle system manufactured by Syntace. In various exemplary embodiments, torque sensing system 500 is configured to be compatible with thru-axle systems having a variety of axle diameters, for example, axle diameters from about 10 mm to about 18 mm.

In an exemplary embodiment, bicycle frame 548 is configured with thru axle 544. An electric motor, for example transverse flux machine 550, is configured to rotate about thru axle 544 in order to propel a bicycle. Cassette body 512 and gear cassette 514 are also configured to rotate about through thru axle 544 while being rotatably supported by bearings 532A and 523B. Torque tube 534 receives a force transferred via bearings 532A and 532B, and experiences a strain detectable by a strain gauge (not shown in FIGS. 5A-5C). Operation of torque sensing system 500 may be similar to operation of torque sensing system 200 described above.

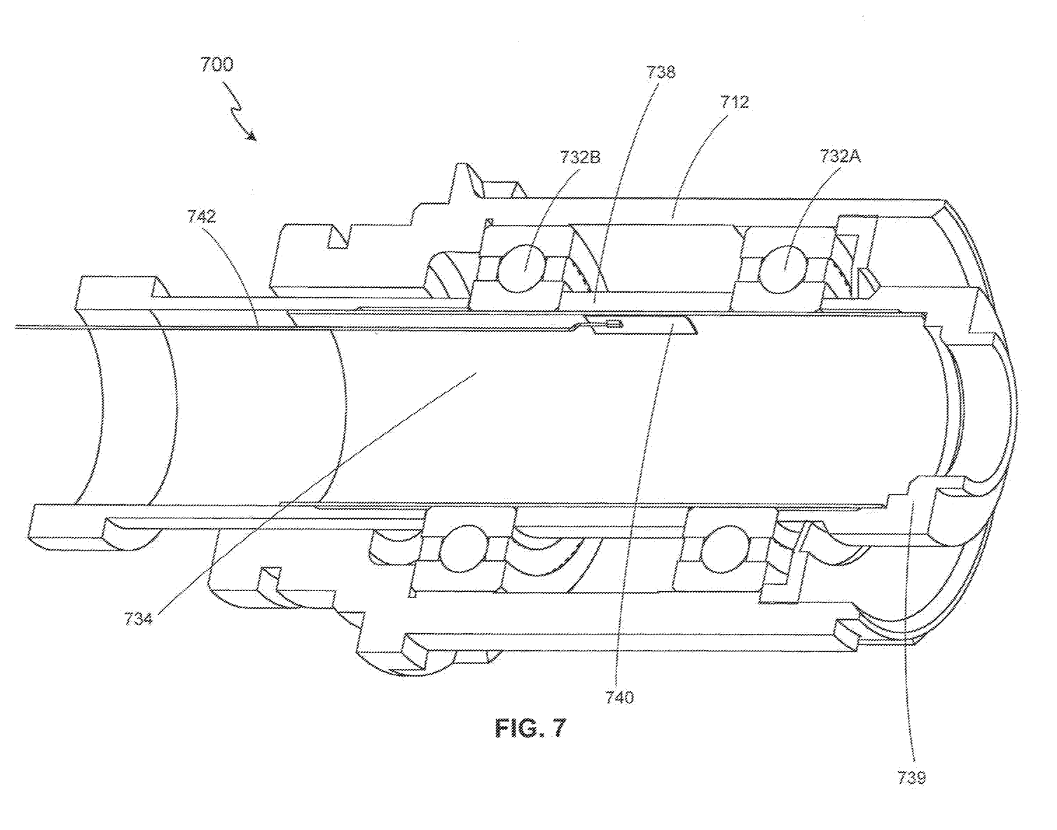

In accordance with an exemplary embodiment, with reference now to FIG. 7, torque sensing system 100, for example torque sensing system 700, comprises a torque tube 734 having strain gauge 740 disposed on the inner side thereof. The output of strain gauge 740 is accessed via wire 742. Bearings 732A and 732B transfer force from cassette body 712 to torque tube 734. Bearing spacer 738 and end cap 739 assist in retaining bearings 732A and 732B in a desired location torque sensing system 700, strain gauge 740 may be protected from damage due to the location on the inner side of torque tube 734, for example damage arising from contact with one or more of bearings 732A, bearing 732B, and/or bearing spacer 738. Moreover, torque sensing system 700 may be waterproof and/or sealed. Additionally, torque tube 734 is free floating. Advantageously, the tolerance burden of torque sensing system 700 is simply the outer diameter (OD) of torque tube 234 to the inner diameter (ID) of bearings 732A and 732B. Other torque sensing systems, for example torque sensing system 200, may have a higher tolerance burden, for example a tolerance burden of the outer diameter of an axle to an inner diameter of a torque tube, and then the outer diameter of a torque tube to the inner diameter of a bearing.

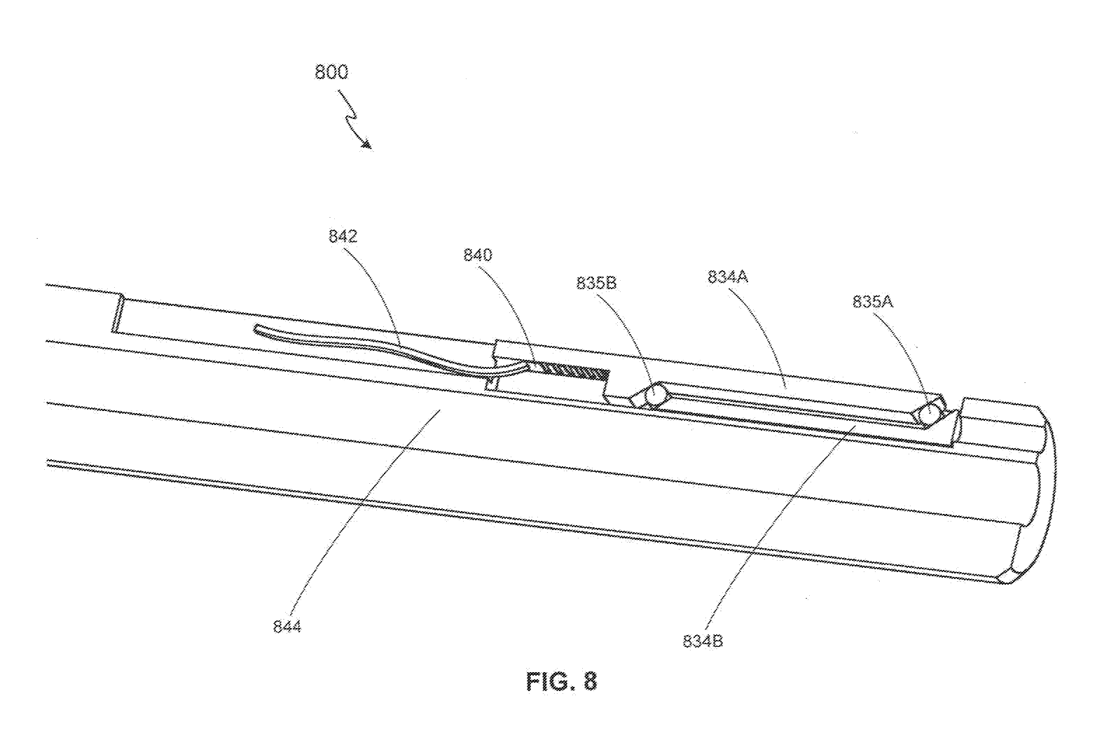

In accordance with another exemplary embodiment, with reference now to FIG. 8, torque sensing system 100, for example torque sensing system 800, comprises a pair of torque plates that are translatable with respect to one another responsive to an applied force. In various exemplary embodiments, torque sensing system 800 comprises a top torque plate 834A and a bottom torque plate 834B with a pair of rollers 835A and 835B disposed between corresponding angled surfaces of top torque plate 834A and bottom torque plate 834B. A strain gauge 840 is affixed to a portion of top torque plate 834A, for example generally on an end portion of top torque plate 834A abutting axle 844. Responsive to a force applied to top torque plate 834A, for example a force generated by a bicycle rider pressing on a bicycle pedal, top torque plate 834A is urged in an axial direction with respect to bottom torque plate 834B due to rollers 835A and 835B. The force is transferred to top torque plate 834A via, one or more components, for example bearings (not shown in FIG. 8). Strain gauge 840 measures the resulting compression on top torque plate 834A. The output of strain gauge 840 may be accessed via any suitable method or components, for example via wires 842. The output of strain gauge 840 may be converted into a measured and/or calculated torque value via any suitable components and/or methods, for example via a Wheatstone bridge and instrumentation amplifier.

Torque sensing system 800 reduces measurement errors arising from the varying position of a chain on a gear cassette, because a force exerted anywhere on top torque plate 834A generates a compressive force measurable by strain gauge 840. In contrast, a 4-point bending beam approach such as the one utilized in torque sensing system 200 may experience significant variations in torque readings arising from the varying portion of a chain on a gear cassette. Moreover, torque sensing system 800 may be configured with adjustable preload feature, for example via use of a set screw (not shown in FIG. 8) to urge bottom torque plate 834B toward top torque plate 834A, causing top torque plate 834A to contact the bearings.

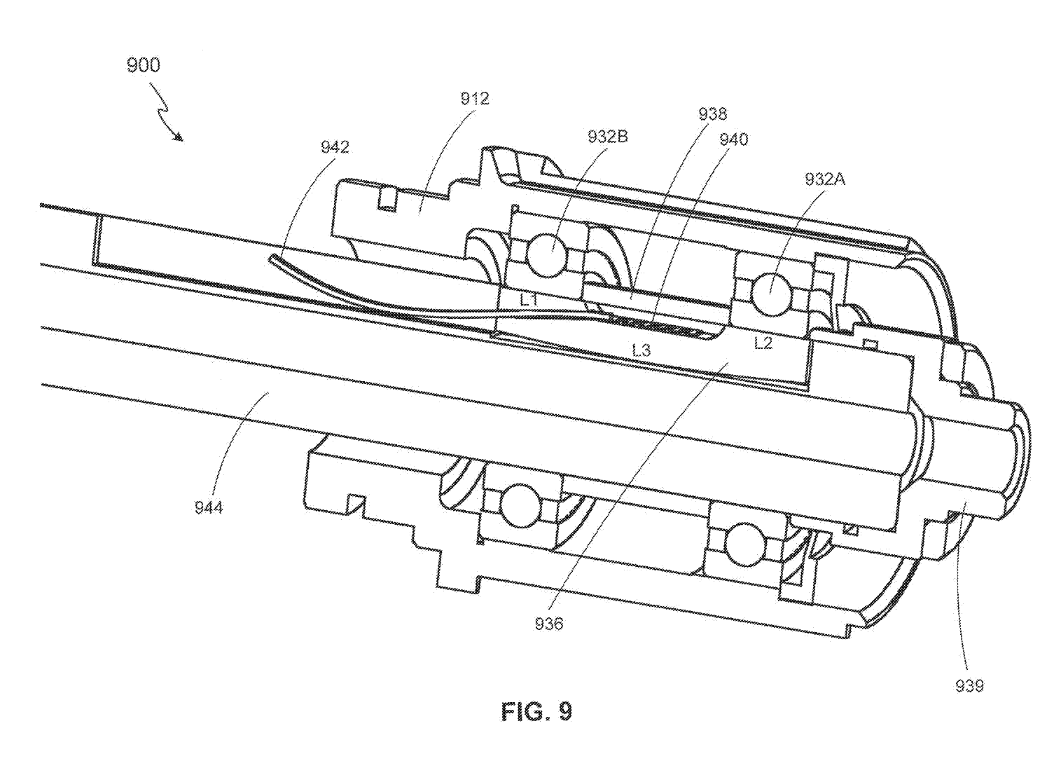

In accordance with an exemplary embodiment, with reference now to FIG. 9, torque sensing system 100, for example torque sensing system 900, comprises a “torque key” that experiences a strain responsive to an applied force. In various exemplary embodiments, torque sensing system 900 comprises a torque key 936 disposed within a slot on axle 944. Torque key 936 may be configured with one or more arched and/or otherwise irregularly shaped, such as having curved and/or angled surfaces, for example in order to contact axle 944 along only a portion of a surface of torque key 936, such as in the general location L3 illustrated in FIG. 9. Torque key 936 may also be configured with a pair of substantially flat surfaces disposed adjacent bearings 932A and 93213, respectively, such as in the general locations L1 and L2 illustrated in FIG. 9. In various exemplary embodiments, torque key 936 may be at least partially arch-shaped. A strain gauge 940 is affixed to a portion of torque key 936. Strain gauge 940 may be affixed to torque key 936 on the “inside” of generally arch-shaped torque key 936 (e.g., on a side facing bearings 932A and 932B), along a sidewall of generally arch-shaped torque key 936 (e.g., on a side facing neither bearings 932A and 932B, nor facing the axis of axle 944), and/or any other suitable location on torque key 936. Bearing spacer 938 and end cap 939 assist in retaining bearings 932A and 932B in a desired location.

Responsive to a force applied to cassette body 912, for example a force generated by a bicycle rider pressing on a bicycle pedal, torque key 936 is at least partially deformed and/or strained. Force is transferred from cassette body 912 to torque key 936 via bearings 932A and 932B. Strain gauge 940 measures the resulting strain in torque key 936. The output of strain gauge 940 may be accessed via any suitable method or components, for example via wires 942. The output of strain gauge 940 may be converted into a measured and/or calculated torque value via any suitable components and/or methods, for example via a Wheatstone bridge and instrumentation amplifier.

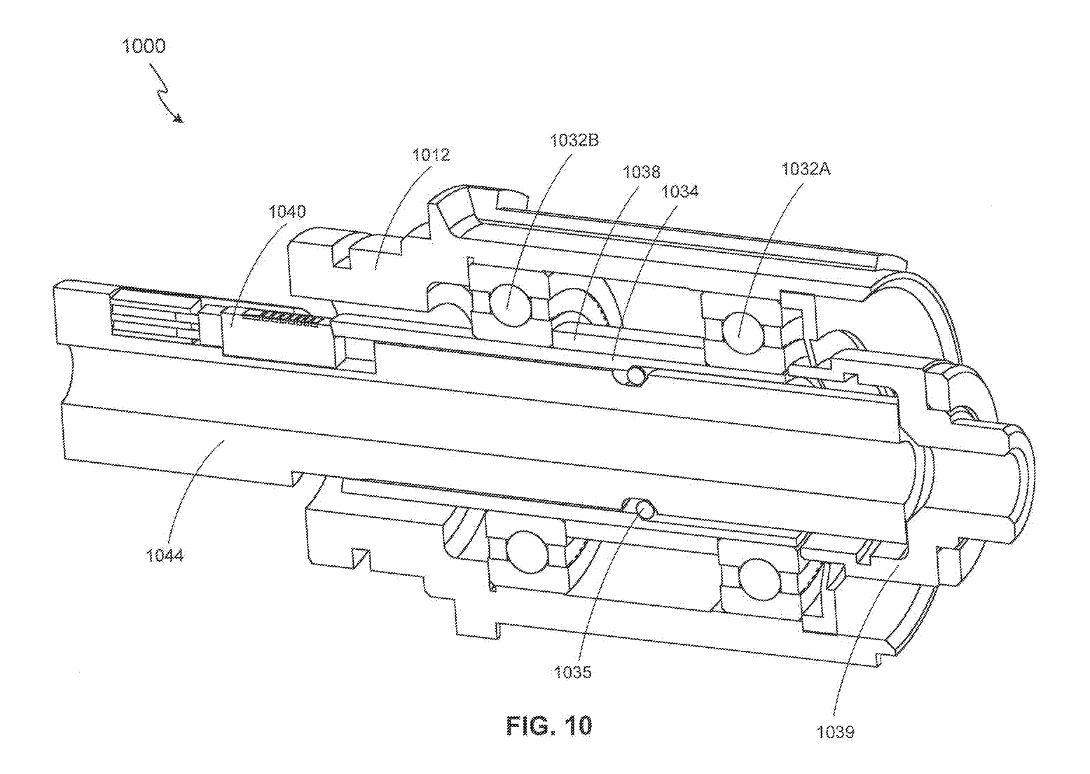

In accordance with an exemplary embodiment, with reference now to FIG. 10, torque sensing system 100, for example torque sensing system 1000, comprises a torque tube that is translatable with respect to an axle responsive to an applied force. In various exemplary embodiments, torque sensing system 1000 comprises a torque tube 1034 and an axle 1044 having one or more ball bearings 1035 disposed between corresponding angled and/or curved surfaces of torque tube 1034 and axle 1044. A compression column 1040 is disposed between torque tube 1034 and axle 1044 in an axial direction, such that axial movement of torque tube 1034 generates a compressive force on compression column 1040. Compression column 1040 may be configured with various strain gauges, load cells, and/or other sensors configured to measure a compressive force on compression column 1040. Bearing spacer 1038 and end cap 1039 assist in retaining bearings 1032A and 1032B in a desired location.

Responsive to a force applied to torque tube 1034, for example a force generated by a bicycle rider pressing on a bicycle pedal, torque tube 1034 is urged in an axial direction with respect to axle 1044 due to ball bearings 1035. The force is transferred to torque tube 1034 from cassette body 1012 via bearings 1032A and 1032B. Compression column 1040 measures the resulting compression. The output of compression column 1040 may be accessed via any suitable method or components, for example via wires, wireless transmission, and/or the like. The output of compression column 1040 may be converted into a measured and/or calculated torque value via, any suitable components and/or methods, for example via a Wheatstone bridge and instrumentation amplifier.

In various exemplary embodiments, torque sensing system 1000 is configured to be position independent; stated another way, torque sensing system 1000 is configured to measure a torque regardless of the orientation of torque sensing system 1000 with respect to other components of a bicycle. For example, as illustrated in FIG. 10, due to the influence of ball bearings 1035, torque tube 1034 will be urged in an axial direction with respect to axle 1044 responsive to any force transferred from bearings 1032A and/or 1032B, regardless of the direction of the force. By providing position independent torque sensing capability, torque sensing system 1000 can enable simplified integration with other components of a vehicle, for example a bicycle, because the need to orient one or more portions of torque sensing system 1000 with respect to the vehicle has been eliminated. In this manner, torque sensing system 1000 can be configured to be compatible with a wider range of vehicles, for example with a range of bicycles having frame designs and drop outs resulting in varying orientations of a chain with respect to gear cassette.

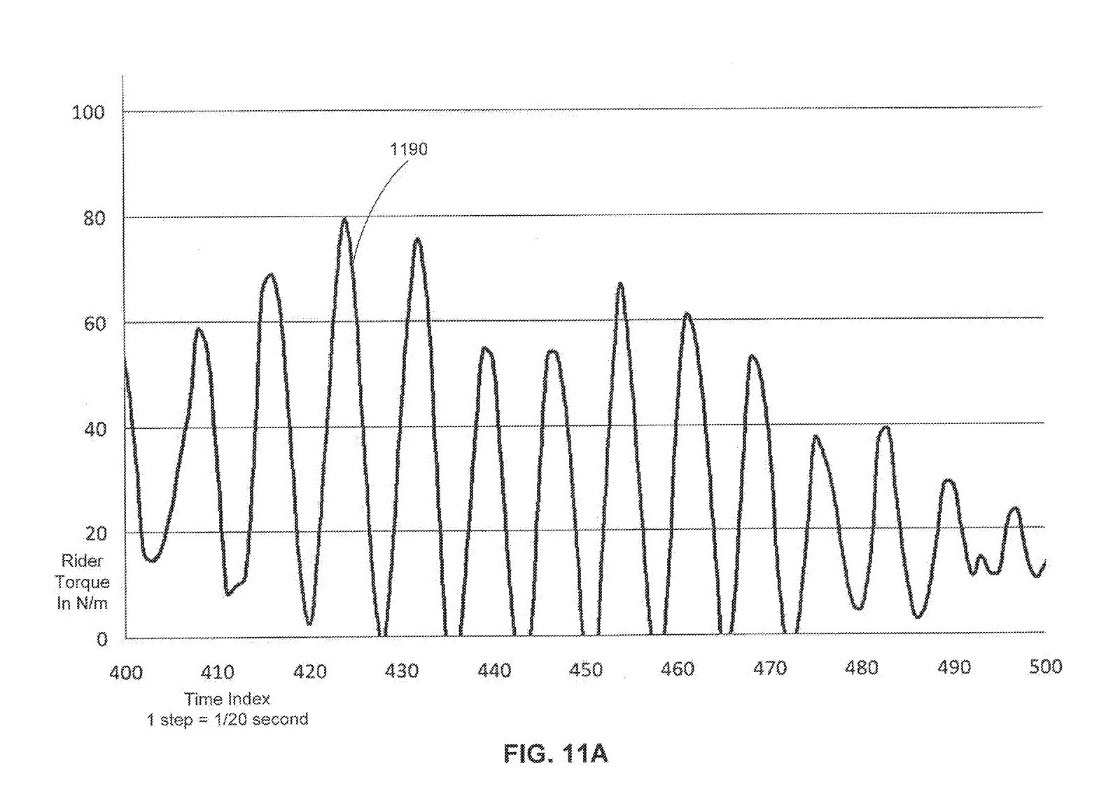

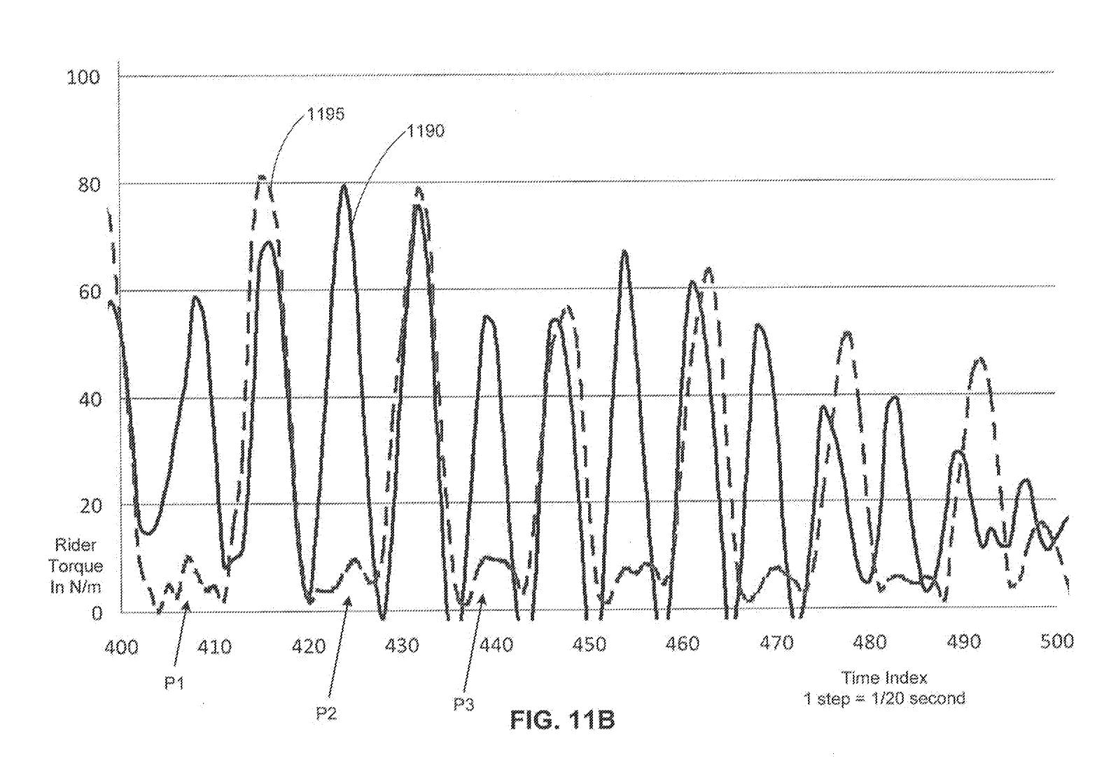

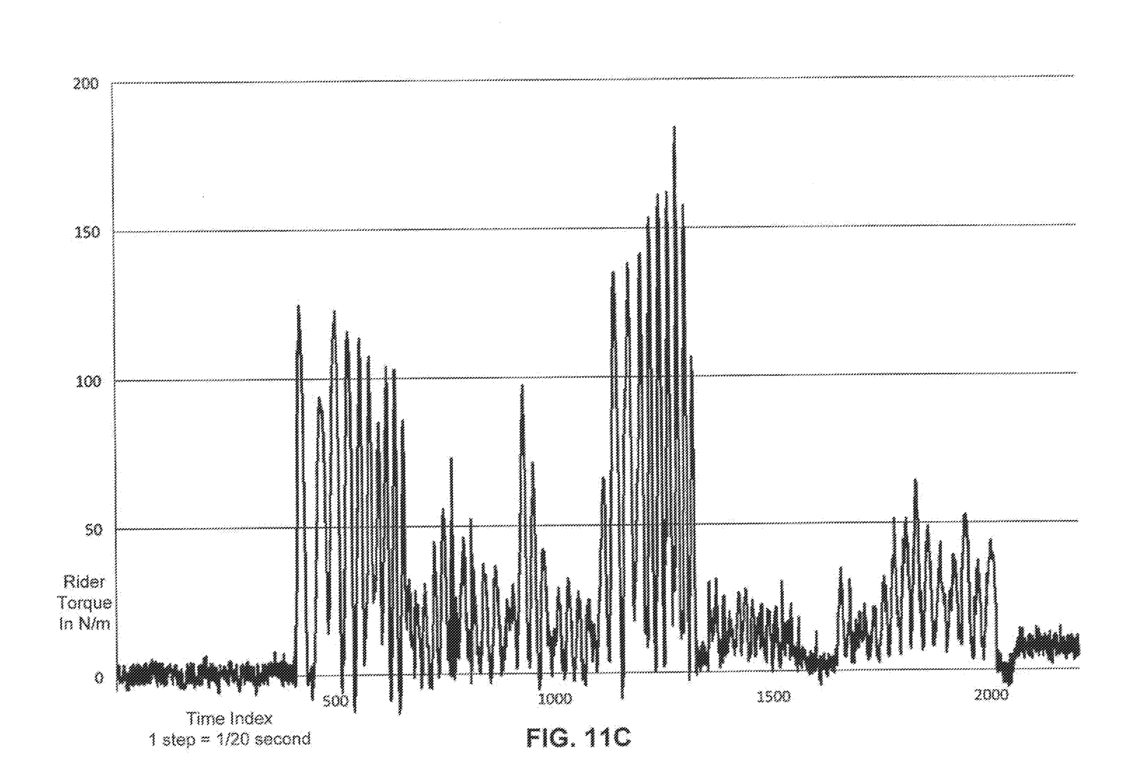

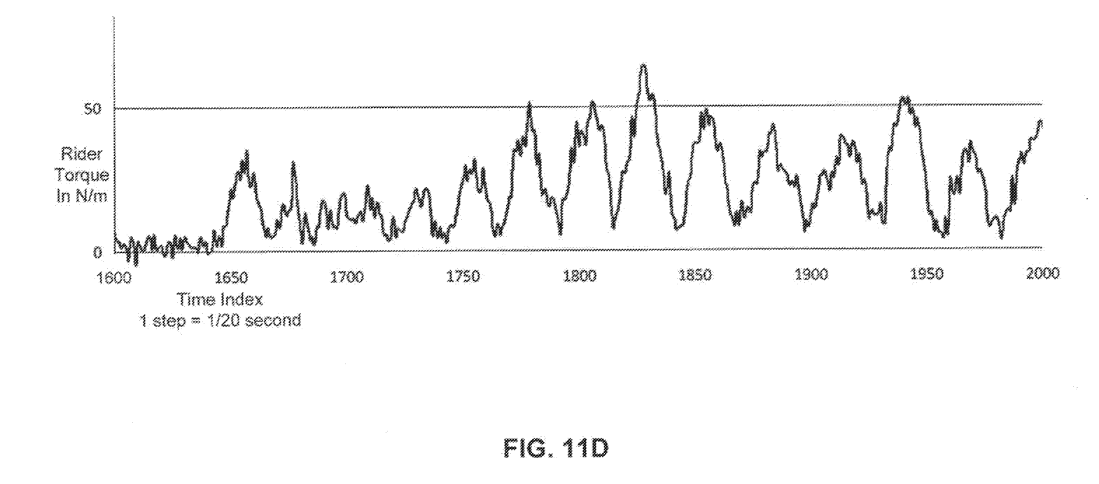

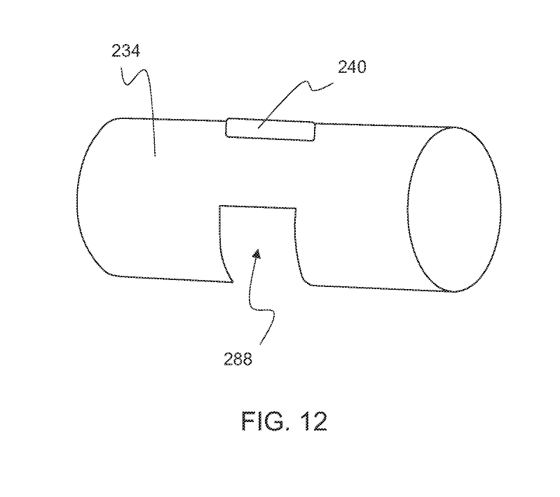

With reference now to FIG. 11A, in an exemplary embodiment the output of torque sensing system 100 may be used to construct an input torque profile 1190, for example a profile of rider torque applied to the pedals of a bicycle. Input torque profile 1190 arises from rider torque alternatingly applied to opposing pedals of a bicycle during conventional pedaling. However, an input torque profile generated by torque sensing system 100 may arise from any suitable forces, as desired.

Turning now to FIG. 11B, input torque profile 1190 constructed from the output of torque sensing system 100 is compared with an input torque profile 1195 constructed from the output of a comparative torque sensing system. Input torque profile 1190 and input torque profile 1195 were captured simultaneously on an electric bicycle. As shown in FIG. 11B, the comparative torque sensing system was able to accurately capture input torque readings only for forces exerted on a single pedal of the bicycle. The failure of the comparative system to accurately capture input torque readings can be seen in the alternating pattern of normal torque peaks and diminished torque peaks in input profile 1195. In contrast, torque sensing system 100 was able to accurately capture input torque readings responsive to forces exerted on either/both pedals of the bicycle. Exemplary instances of the comparative torque sensing system failing to accurately capture input torque readings (with the resulting diminished peaks) are noted at points P1, P2, and P3 in FIG. 11B.

Turning now to FIGS. 11C and 11D, in various exemplary embodiments torque sensing system 100 is configured to sense a wide range of input torques, for example input torques from about 0 N/m to about 250 N/m. Moreover, torque sensing system 100 may be configured to sense a wide range of strains, for example from about 100 micro-strain units to about 30,000 micro-strain units. However, torque sensing system 100 may be configured to limit the amount of strain induced in components of torque sensing system 100, for example in order to reduce material fatigue. In various exemplary embodiments, torque sensing system 100 is configured to limit the amount of strain induced to about 3,000 micro-strain units. Moreover, torque sensing system 100 may be configured with a range of suitable sample rates, for example sample rates from about 5 Hz to about 400 Hz or even higher.

Various of the foregoing exemplary embodiments have been disclosed with use of a strain gauge, compression column, load cell, and/or the like. In various other exemplary embodiments, alternative force and/or torque sensing components may be utilized, for example magnetic displacement sensors, resistive displacement sensors, optical fiber displacement sensors, springs, hydraulic pressure sensors, piezoelectric materials, and/or the like. Additionally, multiple types of force and/or torque sensing components may be utilized in a single torque sensing system 100. Additionally, more than one of the same kind of sensor may be utilized, for example in order to provide error correction, calibration, increased signal to noise ratios, cancellation of tension and/or compression loading effects, and/or the like.

In various exemplary embodiments, torque sensing system 100 is configured to be removable and/or replaceable. For example, in one exemplary embodiment torque sensing system 100 or components thereof are configured to be disconnected from a bicycle frame, for example by unthreading various retaining fasteners. A replacement torque sensing system 100 or components thereof may then be installed.

In certain exemplary embodiments, torque sensing component 130 is configured to communicate via an electrical wire. In other exemplary embodiments, torque sensing component 130 is configured to communicate via wireless communication, for example via a radio frequency. In an exemplary embodiment, torque sensing component 130 communicates wirelessly with a bicycle motor controller and/or other electronic components, such as a bike computer. In another exemplary embodiment, torque sensing component 130 is coupled to a wireless transmitter and/or transceiver for communicating with a bicycle motor controller and/or bike computer. Thus, operation of a bicycle motor may be controlled, modified, started, stopped, and/or the like, responsive to a bicycle user applying a force to a bicycle pedal. Accordingly, torque sensing system 100 may be configured with components compatible with one or more of IEEE 802.15.4 (“Zigbee”); Bluetooth™; IEEE 802.11, IEEE 1451, ISA 100.11a, ANT, ANT+, and/or similar wireless protocols.

Certain exemplary embodiments have been described herein where torque sensing system 100 is coupled to a vehicle having a motor, for example an electric bicycle. In other exemplary embodiments, torque sensing system 100 is coupled to a vehicle lacking a motor, for example a conventional bicycle. Torque sensing system 100 may sense and/or calculate forces applied to the pedals of the bicycle. The output of torque sensing system 100 may be utilized to measure rider performance, to facilitate athletic training and improvement, and/or the like.

Principles of the present disclosure may suitably be combined with various other principles related to transverse flux machines and/or commutated flux machines. For example, principles of the present disclosure may suitably be combined with principles for stators in transverse flux machines and commutated flux machines, for example principles for partial stators and/or gapped stators, as disclosed in U.S. patent application Ser. No. 12/611,728 filed on Nov. 3, 2009, now U.S. Pat. No. 7,851,965 entitled “TRANSVERSE AND/OR COMMUTATED FLUX SYSTEM STATOR CONCEPTS” having common ownership as the present application, the contents of which are hereby incorporated by reference in their entirety.

Principles of the present disclosure may also suitably be combined with principles for rotors in transverse flux machines and/or commutated flux machines, for example tape wound rotors and/or multipath rotors, as disclosed in U.S. patent application Ser. No. 12/611,733 filed on Nov. 3, 2009, now U.S. Patent Application Publication No. 2010/0109452, entitled “TRANSVERSE AND/OR COMMUTATED FLUX SYSTEM ROTOR CONCEPTS” having common ownership as the present application, the contents of which are hereby incorporated by reference in their entirety.

Principles of the present disclosure may also suitably be combined with principles of polyphase transverse flux machines and/or polyphase commutated flux machines as disclosed in U.S. patent application Ser. No. 12/611,737 filed on Nov. 3, 2009, now U.S. Pat. No. 7,868,508 entitled “POLYPHASE TRANSVERSE AND/OR COMMUTATED FLUX SYSTEMS” having common ownership as the present application, the contents of which are hereby incorporated by reference in their entirety.

Principles of the present disclosure may also suitably be combined with principles of extended magnets, overhung rotors, and/or stator tooth overlap in transverse flux machines and/or commutated flux machines as disclosed in U.S. patent application Ser. No. 12/772,958 filed on May 3, 2010, entitled “TRANSVERSE AND/OR COMMUTATED FLUX SYSTEMS CONFIGURED TO PROVIDE REDUCED FLUX LEAKAGE, HYSTERESIS LOSS REDUCTION, AND PHASE MATCHING” having common ownership as the present application, the contents of which are hereby incorporated by reference in their entirety.

Principles of the present disclosure may also suitably be combined with principles of utilization of transverse flux machines and/or commutated flux machines in electric bicycles as disclosed in U.S. patent application Ser. No. 12/772,959 filed on May 3, 2010, entitled “TRANSVERSE AND/OR COMMUTATED FLUX SYSTEMS FOR ELECTRIC BICYCLES” having common ownership as the present application, the contents of which are hereby incorporated by reference in their entirety.

Principles of the present disclosure may also suitably be combined with principles of phase offset in transverse flux machines and/or commutated flux machines as disclosed in U.S. patent application Ser. No. 12/772,962 filed on May 3, 2010, entitled “TRANSVERSE AND/OR COMMUTATED FLUX SYSTEM PHASE OFFSET” having common ownership as the present application, the contents of which are hereby incorporated by reference in their entirety.

Principles of the present disclosure may also suitably be combined with principles of segmented stator laminations and/or rainbow laminations in transverse flux machines and/or commutated flux machines as disclosed in U.S. Provisional Patent Application No. 61/414,769 filed Nov. 17, 2010 and entitled “TRANSVERSE AND/OR COMMUTATED FLUX SYSTEMS HAVING SEGMENTED STATOR LAMINATIONS” having common ownership as the present application, the contents of which are hereby incorporated by reference in their entirety.

Principles of the present disclosure may also suitably be combined with principles of adjustable Hall effect sensor systems as disclosed in U.S. Provisional Patent Application No. 61/414,769 filed Nov. 17, 2010 and entitled “TRANSVERSE, AND/OR, COMMUTATED FLUX SYSTEMS HAVING SEGMENTED STATOR LAMINATIONS” having common ownership as the present application, the contents of which are hereby incorporated by reference in their entirety.

Principles of the present disclosure may also suitably be combined with principles of coils, including dual wound coils in transverse flux machines and/or commutated flux machines as disclosed in U.S. Provisional Patent Application No. 61/414,774 filed Nov. 17, 2010 and entitled “TRANSVERSE AND/OR COMMUTATED FLUX SYSTEM COIL CONCEPTS” having common ownership as the present application, the contents of which are hereby incorporated by reference in their entirety.

Principles of the present disclosure may also suitably be combined with principles of laminations combined with powdered metal portions in transverse flux machines and/or commutated flux machines as disclosed in U.S. Provisional Patent Application No. 61/414,781 filed Nov. 17, 2010 and entitled “TRANSVERSE AND/OR COMMUTATED FLUX SYSTEMS HAVING LAMINATED AND POWDERED METAL PORTIONS” having common ownership as the present application, the contents of which are hereby incorporated by reference in their entirety.

Principles of the present disclosure may also suitably be combined with principles of adjustable Hall effect sensor systems as disclosed in a U.S. Provisional Patent Application entitled “ADJUSTABLE HALL EFFECT SENSOR SYSTEM” having the same filing date and common ownership as the present application, the contents of which are hereby incorporated by reference in their entirety.

Principles of the present disclosure may also suitably be combined with principles of laminations combined with powdered metal portions in transverse flux machines and/or commutated flux machines as disclosed in a U.S. Provisional Patent Application entitled “TRANSVERSE AND/OR COMMUTATED FLUX SYSTEMS HAVING LAMINATED AND POWDERED METAL PORTIONS” having the same filing date and common ownership as the present application, the contents of which are hereby incorporated by reference in their entirety.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection.

What is claimed is:

1. A torque sensing system, comprising:
a torque tube disposed around an axle; and
a strain gauge disposed on the torque tube,
wherein the torque tube experiences a strain responsive to an pedaling force, and wherein at least a portion of the pedaling force is transferred to the torque tube via at least one support bearing.

2. The torque sensing system of claim 1, further comprising a gap between said torque tube and axle.

3. The torque sensing system of claim 2, wherein the gap is configured at least partially under said support bearing.

4. The torque sensing system of claim 1, comprising two support bearings and wherein the strain gauge is disposed between said support bearings.

5. The torque sensing system of claim 4, wherein the torque sensing system is configured in a 4-point bending system.

6. The torque sensing system of claim 4, wherein the torque tube has a length, and a first inner diameter over a portion of the length and a second inner second diameter over a portion of the length.

7. The torque sensing system of claim 4, further comprising at least one bearing disposed between said torque tube and axle between said support bearings.

8. The torque sensing system of claim 1, wherein said strain gauge is configured on the inner diameter of the torque tube.

9. The torque sensing system of claim 1, wherein of the torque tube comprises an outer diameter having strain gauge configured thereon, and at least one recess, and wherein said support bearing is configured over said recess.

10. The torque sensing system of claim 9, further comprising stain gauge leads configured to extend through said recess.

11. The torque sensing system of claim 1, wherein said strain gauge is configured to substantially align with a portion of the drive chain in tension.

12. The torque sensing system of claim 1, further comprising translatable torque plates with a pair of rollers disposed there between.

13. The torque sensing system of claim 1, further comprising a torque key.

14. The torque sensing system of claim 1, wherein said torque tube comprises flanges for retaining a support bearing.

15. The torque sensing system of claim 1, wherein said torque tube is configured to be stationary.

16. The torque sensing system of claim 1, wherein the torque tube is configured on a bicycle around a bicycle axle.

17. The torque sensing system of claim 17, wherein the bicycle is an e-bike having an electric motor.

18. The torque sensing system of claim 18, wherein the strain gauge is connected with said electric motor, and whereby a signal from said strain gauge changes an output from the electric motor.

19. The torque sensing system of claim 17, wherein the electric motor is a transverse flux electric motor.

20. The torque sensing system of claim 17, wherein the torque tube is configured around a bicycle axle, and wherein the strain gauge is disposed on the torque tube in a location within 15 angular degrees of the location on the torque tube closest to a bottom bracket of said bicycle.
